(19) United States
(12) Patent Application Publication
(10) Pub. No.: US 2013/0060612 A1
(43) Pub. Date: Mar. 7, 2013

(54) Parliamentary Collaboration and Democratic Database System, Method, and Computer Program Product

(71) Applicant: James Hurd, Media, PA (US)

(72) Inventor: James Hurd, Media, PA (US)

(21) Appl. No.: 13/607,658

(22) Filed: Sep. 7, 2012

Related U.S. Application Data
(60) Provisional application No. 61/532,087, filed on Sep. 7, 2011.

(51) Int. Cl. G06Q 10/06

(52) U.S. Cl. 705/12; 705/342

(57) ABSTRACT

An exemplary networking system incorporating parliamentary procedures where standards may be built, debated, adopted and enforced by a plurality of organizations and users is set forth. The parliamentary procedure of each organization is itself a standard, which may be managed by the system. A system, method and/or computer program product may include a method for building structured documents by a collaborative process over computer networks, including: receiving, by at least one processor, from one or more organization(s) a configurable parliamentary structure; receiving, by the at least one processor, from the organization(s) at least one organizational bylaw for the organization(s) defined in at least one document; and receiving, by the at least one processor, at least one edit for the at least one document, adoptable by the organization(s); wherein said at least one organizational bylaw comprises computer readable instructions enforceable by the at least one processor system.

### CROSS-REFERENCE TO RELATED APPLICATIONS

This application is related to and claims the benefit under 35 USC Section 119 (e) of U.S. Provisional Patent Application Ser. No. 61/532,087, confirmation no. 5534, filed Sep. 7, 2011, to James Hurd, entitled “Parliamentary Collaboration System, Method and Computer Program Product,” of common assignee to the claimed invention, the contents of which are incorporated herein by reference in their entirety.

### BACKGROUND OF THE INVENTION

### Related Art

The term computer supported cooperative work (CSCW) first coined by Irene Greif and Paul M. Cashman in 1984, refers to hardware, software, services and techniques, which can be used to mediate human communication. CSCW refers to computer systems built to support groups rather than individuals who are working together on shared tasks.

Collaborative technologies can bring individual members of groups together. Conventional collaborative technologies include, e.g., video conferencing, instant messaging (IM), chat, virtual worlds, group calendars, electronic mail, multi-user editors, etc.

Technology can both make communication more efficient, e.g., by bringing people together, as well as make communication less efficient, by allowing anarchy to develop, e.g., by flaming.

Robert's Rules of Order describe an orderly process for people meeting together face-to-face to make decisions fairly. One of the most important fairness criterion was that although every attendee would have opportunities to make his or her ideas heard, the minority could not prevent the majority from making decisions. In 1876, Major Henry Robert of the U.S. Army Engineers first published Robert's Rules of Order, for running orderly meetings in which each participant would have an opportunity to express that participant's own opinion but no one could prevent a deliberative majority from coming to a decision. This seemingly simple requirement occupied Henry Robert for almost forty years, demonstrating the inherent complexity of such a goal. Robert's Rules of Order are now in daily use by tens of thousands of deliberative bodies worldwide from the smallest neighborhood organizations to multi-national organizations such as the United Nations, from groups whose members are in the tens, to those with membership in the thousands.

What is needed is an improved system to enable collaboration among disparate members of a group that overcomes shortcomings of conventional solutions.

### SUMMARY OF THE INVENTION

Various exemplary embodiments of a system, method and computer program product for providing a platform for receiving search queries and providing search results according to various exemplary embodiments of the present invention, are set forth.

According to an exemplary embodiment of the present invention, a system, method and/or a computer program product may include a method for building structured documents by a collaborative process over computer networks, the method comprising: receiving, by at least one processor, from at least one organization at least one configurable parliamentary structure; receiving, by the at least one processor, from the at least one organization at least one organizational bylaw for the at least one organization defined in at least one document; and receiving, by the at least one processor, at least one edit for said at least one document, adoptable by the at least one organization; wherein said at least one organizational bylaw comprises computer readable instructions enforceable by the at least one processor system.

The method according to an exemplary embodiment may further include, receiving at least one document kept in multiple versions with versions identifiable with alphanumeric tags; receiving at least one tagged version adoptable using at least one voting procedure defined within at least one organization's parliamentary procedure (OPP).

The method according to an exemplary embodiment may further include, receiving membership qualifications of the at least one organization defined within the adopted organization parliamentary procedure and enforced by the at least one processor system.

The method according to an exemplary embodiment where the membership qualification involves payment to an organizational purse (dues).

The method according to an exemplary embodiment where the membership qualification members hold organizational offices in a manner controlled by at least one organization's parliamentary procedure (OPP).

The method according to an exemplary embodiment where the offices held by a user affects the voting procedure as defined with at least one organization's parliamentary procedure (OPP).

The method according to an exemplary embodiment where the users may participate in multiple organizations simultaneously and hold multiple offices.

The method according to an exemplary embodiment where document adoption is scheduled to take place at a specified time and date.

The method according to an exemplary embodiment where each user is allowed to express support or opposition to adoption by varying degrees.

The method according to an exemplary embodiment may further include, creating a relational graph built to allow the system to track allies and oppositional users.

The method according to an exemplary embodiment may further include, organizational graphs allowing hierarchical organizational structure to be easily browsed.

The method according to an exemplary embodiment may further include, a configurable news feed component displaying to at least one user a time or relevancy ordered summation of recent activity of interest by other users.

The method according to an exemplary embodiment may further include, authentication controls for documents to limit users allowed to at least one of view, edit, or adopt resolutions related to the document.

The method according to an exemplary embodiment may further include, enforcing, by checkpoint logic, adopted documents or reporting breaches of adopted documents.

The method according to an exemplary embodiment may further include, communicating rapidly document changes to users holding appropriate authorization.

The method according to an exemplary embodiment may further include, communicating by users within online meeting activities as defined within the OPP.

The method according to an exemplary embodiment may further include, schema documents within the system define structure of documents that are instances of that schema, and collecting document instances, and allowing search of document instances (cases) that are at least one of: valid instances of the schema, or invalid instances of the schema.

The method according to an exemplary embodiment may further include, in a case of invalid instances, displaying deviant aspects of an intended instance.

The method according to an exemplary embodiment may further include, federating a plurality of systems together to allow organizations that span multiple systems connected by an inter-network to access said plurality of systems.

The method according to an exemplary embodiment may further include, at least one of: importing; or exporting from the system using at least one format.

The method according to an exemplary embodiment may further include, maintaining at least one document in a plurality of languages with at least one of automatic or human guided translation, and a user interface distinguishing difference sources of translation.

The method according to an exemplary embodiment may further include, checkpoint software aggregating cases in at least one way comprising at least one of: scheduled file import, or publicly available application programming interface (API) or services.

The method according to an exemplary embodiment may further include, at least one of: document validation extended with general programming languages kept in coordinated source control, or document validation adopted in accordance with OPP.

The method according to an exemplary embodiment may further include, at least one of: document validation extended with general relational databases and queries against the general databases kept in coordinated source control, or document validation extended with general relational databases adopted in accordance with OPP.

The method according to an exemplary embodiment where core bylaw system is extensible by programming in a plurality of programming languages comprising at least one of C++, or Python.

The method according to an exemplary embodiment where execution of bylaw code is secured by a virtual machine.

The method according to an exemplary embodiment where meeting participants are assisted in access and use of organizational bylaws, comprising a mobile platform, and at least one of searching or viewing the bylaws or rules of order.

The method according to an exemplary embodiment where documents are enabled for rapid search comprising at least one of: receiving a user query; or providing results from multiple projects.

The method according to an exemplary embodiment may further include, receiving a user search query for archived revisions of documents.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears:

FIG. 1 depicts an exemplary diagram of an exemplary flow diagram illustrating exemplary general usage of an exemplary embodiment of the invention, according to an exemplary embodiment;

FIG. 2 depicts an exemplary typical hardware architecture configuration illustrating an exemplary system adapted to facilitate sharing of data through an exemplary inter-network, according to an exemplary embodiment;

FIG. 3 depicts an exemplary diagram of an exemplary process for calling an exemplary meeting, according to an exemplary embodiment;

FIG. 4 depicts an exemplary screen depiction of an exemplary user interface of an exemplary meeting process, according to an exemplary embodiment;

FIG. 5 depicts an exemplary screen depiction of an exemplary user interface illustrating an exemplary document history screen, in an exemplary reverse chronological listing, according to an exemplary embodiment;

FIG. 6 depicts an exemplary screen depiction of an exemplary user interface illustrating an exemplary project home screen, according to an exemplary embodiment;

FIG. 7 depicts an exemplary screen depiction of an exemplary user interface illustrating an exemplary organization home screen, according to an exemplary embodiment;

FIG. 8 depicts an exemplary screen depiction of an exemplary user interface illustrating an exemplary system user home screen, according to an exemplary embodiment;

FIG. 9 depicts an exemplary screen depiction of an exemplary extensible structured editor, according to an exemplary embodiment;

FIG. 10 depicts an exemplary diagram of an exemplary computing device hardware architecture illustrating an exemplary device as may be used in any of various client, host, peer and/or server devices, according to an exemplary embodiment of the present invention;

FIG. 11 depicts an exemplary structure of exemplary bylaw documents, according to an exemplary embodiment;

FIG. 12 depicts an exemplary structure of meeting documents, according to an exemplary embodiment;

FIG. 13 depicts an exemplary structure of user profile documents, according to an exemplary embodiment;

FIG. 14 depicts an exemplary structure for defining an exemplary new set of parliamentary procedures, according to an exemplary embodiment;

FIG. 15 depicts an exemplary structure for defining an exemplary new server cluster, according to an exemplary embodiment;

FIG. 16 depicts an exemplary document structure which may be adapted to provide an exemplary new project interface, according to an exemplary embodiment;

FIG. 17 depicts an exemplary shared structure element, which may be utilized within an exemplary higher level structure, according to an exemplary embodiment; and

FIG. 18 depicts an exemplary user interface illustrating an exemplary top level data structure of the present invention, according to an exemplary embodiment.

FIG. 19 depicts an exemplary diagram illustrating a diff and patch, according to an exemplary embodiment. Schemas and Proposals

Schemas serve an expanded role in DDB. Schemas are the basis for tracking changes, branching, and merging.

### DETAILED DESCRIPTION OF VARIOUS EXEMPLARY EMBODIMENTS OF THE INVENTION

### Introduction

Many organizations may operate under a formal set of bylaws that may be modified over time using a formal process such as, e.g., but not limited to, Roberts Rules of Order. Examples of such an organization may include, e.g., but not limited to, a membership group, a professional organization, an association, an industry association, a parent teacher association (PTA), a bar association, a company, a corporation, a partnership, a committee, a nonprofit organization, a for profit organization, a charitable organization, a governmental organization, a public organization, a private organization, a committee, a membership group, etc. Further, these organizations may maintain databases of information such as, e.g., but not limited to, membership information, meetings held, votes taken, and/or resolutions passed, etc. All of this information/data may change over time and may be desirable to capture a history of the changes, to maintain a record, enable search and/or review of the history, etc.

Organizations may also have a need to cooperate or collaborate with other organizations using formalized communication. For example, but not limited to, organizations may require electronic interchange for operations such as, e.g., but not limited to, invoicing and/or explanation of payments, etc. Some conventional formalized document standards include, e.g., but not limited to, electronic data interchange (EDI), electronic business using extensible markup language (ebXML), and universal business language (UBL), etc. Typically these standards are the shared responsibility of a trade association made up of various stakeholder organizations that each may contribute to the process of designing and modifying the standards over time. These trade associations may adopt their own bylaws as well as pass resolutions related to their ongoing activities. Resolutions may need to be voted on by, e.g., but not limited to, diverse stakeholder organizations, e.g., around the world, and when the resolutions pass, the new changes must be disseminated to all interested parties. In the case of resolutions related to interchange standards, there may be a need to test documents to verify that the interchange standards are in compliance with the resolutions.

According to an exemplary embodiment of the present invention, a system, method and/or computer program product may be provided that may include, in an exemplary embodiment, automating the process of, e.g., but not limited to, proposing resolutions, debating resolutions, deciding on resolutions, storing a history of organization resolutions, and/or automatically enforcing those resolutions. According to an exemplary embodiment, the resolutions may be related to electronic interchange standards. According to an exemplary embodiment, such an exemplary system, method and/or computer program product may greatly ease a burden of an interchange standard-setting process of a substantial number of organizations, according to one exemplary embodiment.

### Overview

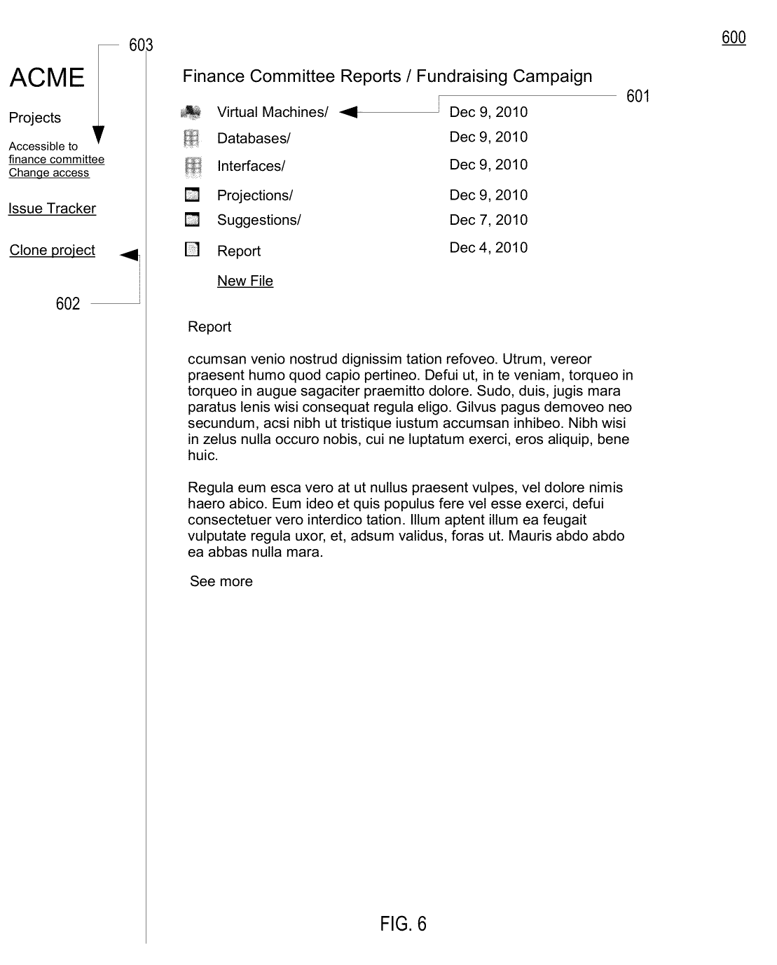

An exemplary embodiment of the present invention may provide an exemplary system, method, and/or computer program product that may run, in an exemplary embodiment, on one or more, or a cluster of computing devices, which may communicate via a network, such as, e.g., but not limited to, an internetwork (such as, e.g., but not limited to, the global Internet), or an intranetwork. According to an exemplary embodiment, one or more users can form an organization by creating and/or editing an existing bylaws document, using an exemplary bylaws editor, according to an exemplary embodiment. According to an exemplary embodiment, a resolution document may be edited via an electronic system or method. According to an exemplary embodiment, the resolution may be made to conform to various schema restrictions using schemas appropriate to the resolution being considered for passage. According to an exemplary embodiment, one or more database(s) may be maintained transactionally within the exemplary resolution system. For example, according to an exemplary embodiment, a motion may be received by the exemplary system or method to add one or more records to an exemplary project database, and if the resolution carries, the one or more additional records may be added to the project database. According to an exemplary embodiment, if the resolution fails, then the motion to add the one or more records may still be retrieved for user access from an exemplary history of motions acted upon, but the unadded records may not be shown in the database view, in an exemplary embodiment. According to an exemplary embodiment, proposed updates to an exemplary document or database can be seen in near real-time by an authorized user. According to an exemplary embodiment, a user may alternatively “clone” a set of previously existing exemplary documents and then may apply changes to the previously existing documents at a time of the user's choosing. See, e.g., but not limited to FIG. 6, at element 602.

According to an exemplary embodiment, an exemplary system, method, and/or computer program product may include a system referred to as a DATAGROVE system or method available from Datagrove, Inc. of Media, Pa., USA. of generating and/or modifying organization bylaws and recording of agendae and/or minutes and/or enforcing bylaws and/or resolutions in an exemplary group collaboration system. According to an exemplary embodiment, an exemplary user(s) of the system may be associated with one or more organization(s), each of which organization may have its own associated set of bylaws.

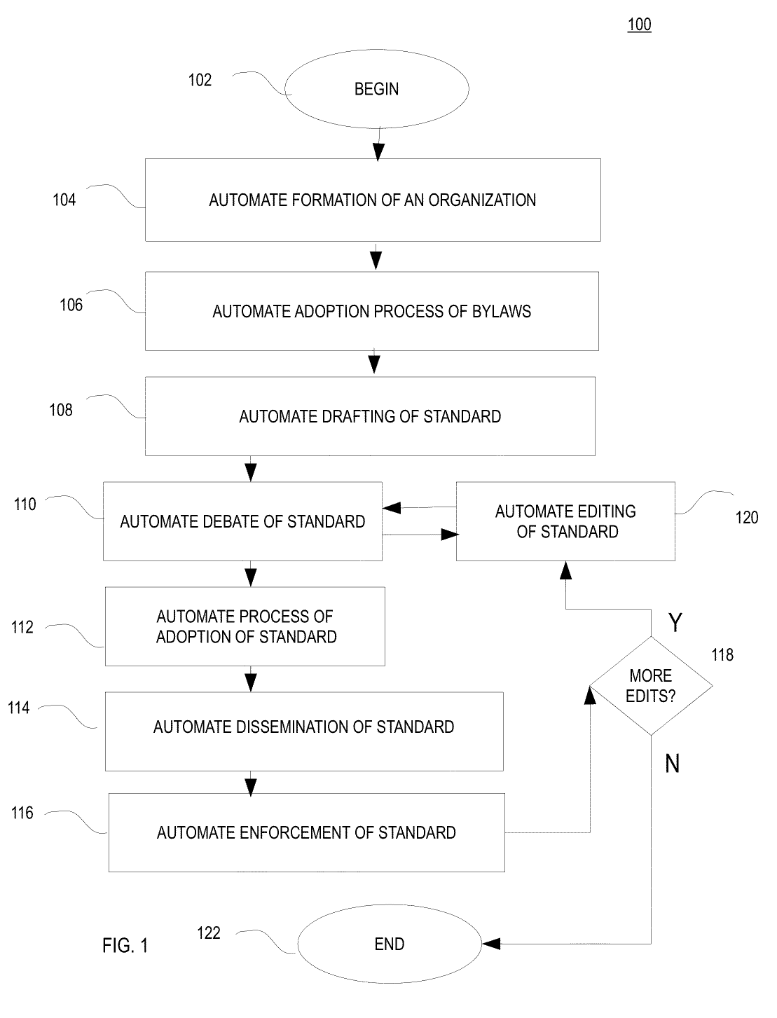

According to an exemplary embodiment, the bylaws and/or group structure may be kept in an exemplary bylaw project by the system or method, and may be editable in the same manner as other projects. See, e.g., but not limited to FIG. 1, at element 1002.

According to an exemplary embodiment, the content of the bylaws may be further enforced by the system. For example, if an exemplary ⅔'s majority vote by directors is called for in a given organization's bylaws in order to change the bylaws, then an exemplary system may only effect the change in response to passage of a requisite exemplary ⅔'s majority vote by the directors. According to an exemplary embodiment, the bylaws can establish standing committees and/or various membership classes that may then be implemented within the exemplary system.

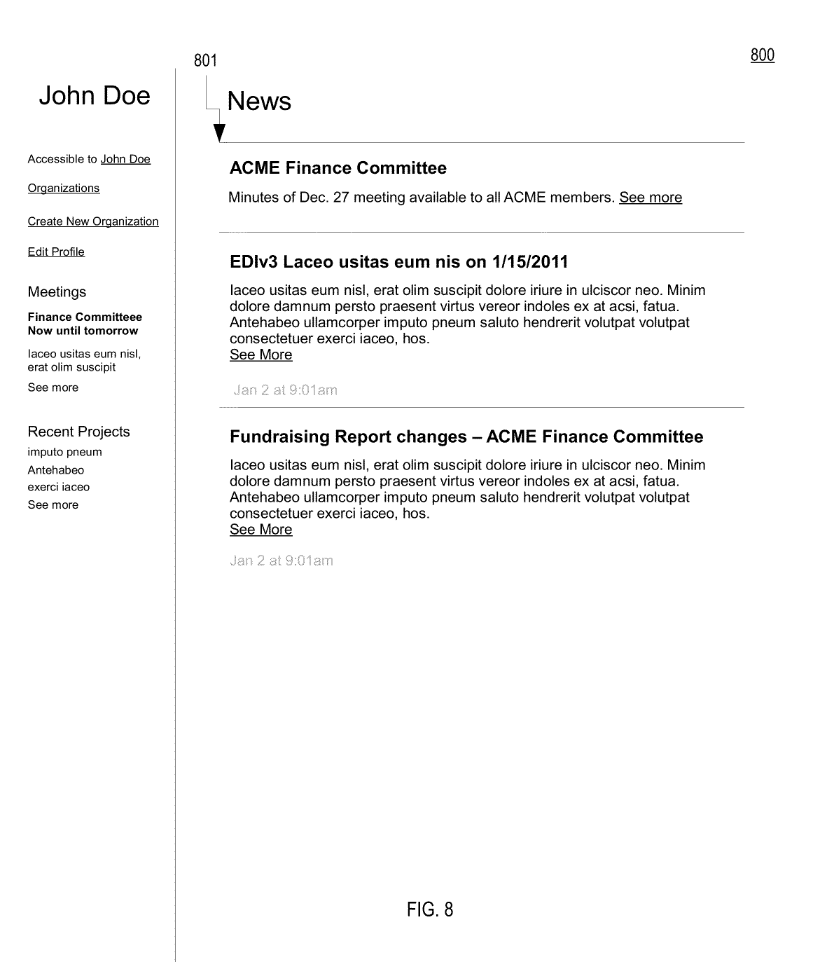

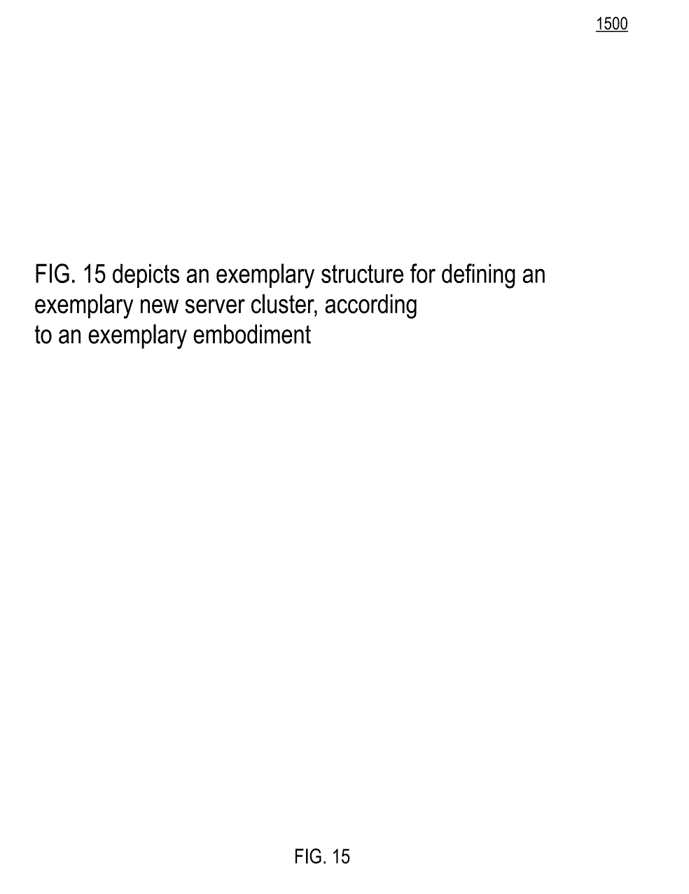

According to an exemplary embodiment, projects may be created and/or may be adopted by an organization's users representing the configuration of exemplary virtual machines. [See FIG. 8, 801] According to an exemplary embodiment, the exemplary virtual machines may provide a set of services, which may be integrated with the exemplary bylaws and/or document editors, according to an exemplary embodiment. See, e.g., but not limited to FIG. 15, at element 1501.

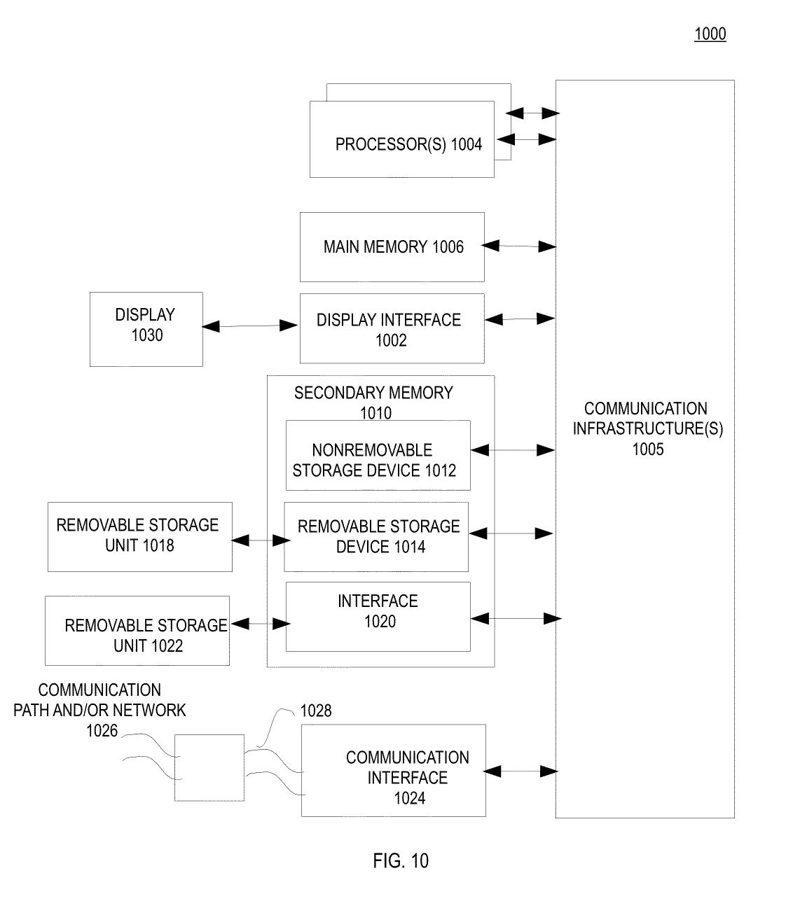

According to an exemplary embodiment, a project may include, e.g., but not limited to, a calender, which may be used to, e.g., but not limited to, trigger events in the exemplary collaboration system and/or the virtual machines. See, e.g., but not limited to FIG. 10, at element 1001.

According to an exemplary embodiment, a project may have one or more interfaces, which may be defined to allow the exemplary project to be used to extend the functionality of the exemplary system. According to an exemplary embodiment, a particular project may be used to define an exemplary new document type, an exemplary diff and patch algorithm, and/or an editor extension by implementing an exemplary interface “document type library.” See, e.g., but not limited to FIG. 15, at element 1501.

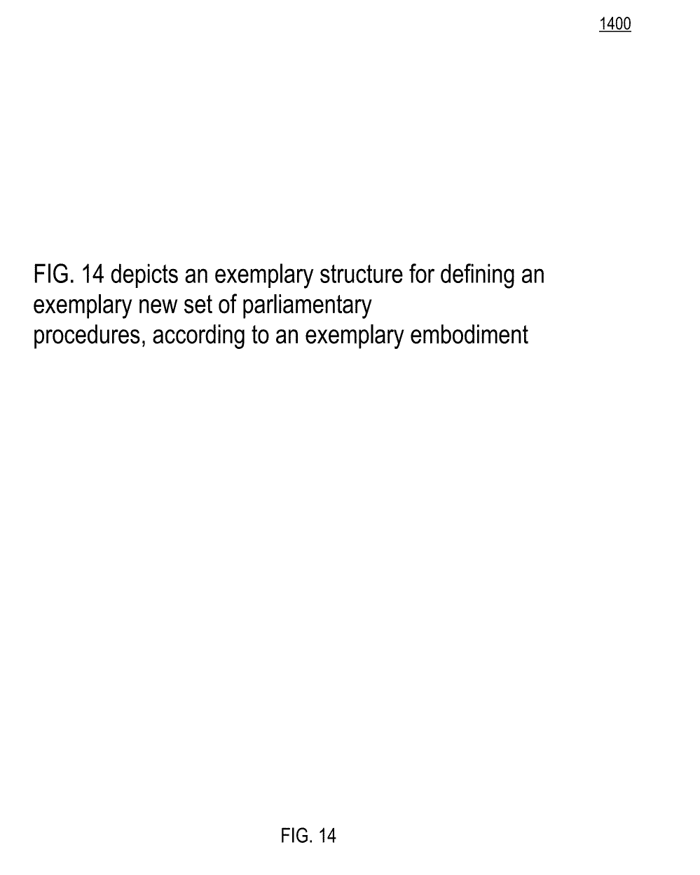

According to an exemplary embodiment, one or more hosting systems may be, e.g., but not limited to, federated together over, e.g., but not limited to, an internet. According to an exemplary embodiment, each hosting system may, e.g., but not limited to, manage an overlapping set of users, organizations, and/or projects, and thus may need to share and/or synchronize, etc., data with each other. According to an exemplary embodiment, each exemplary federated system may run the organization's virtual machines, e.g., but not limited to, locally or via proxy services, to another federated machine running the exemplary virtual machine. See, e.g., but not limited to FIG. 14, at element 1401.

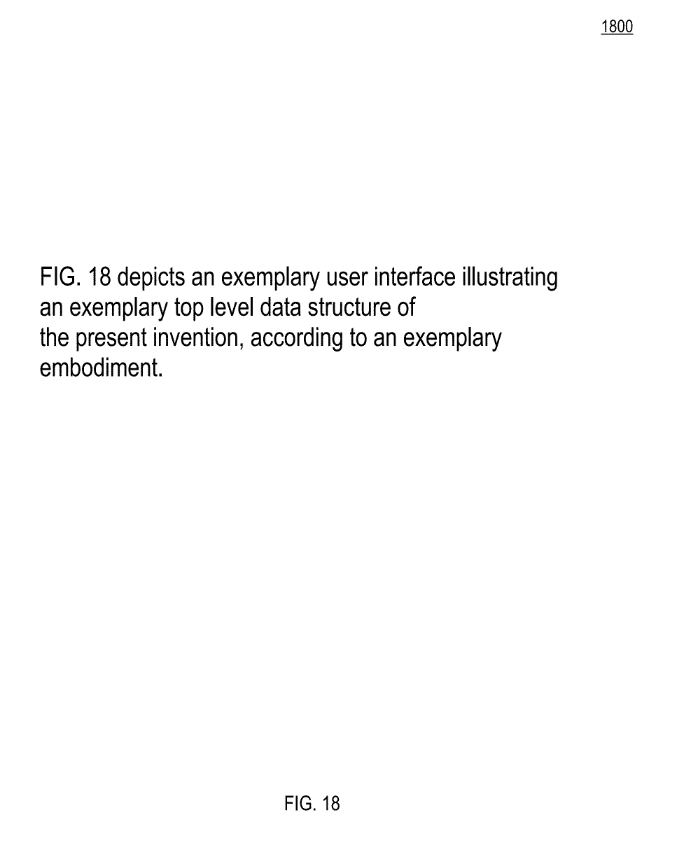

According to an exemplary embodiment, the exemplary collaboration system, according to one exemplary embodiment, can be extended, e.g., but not limited to, by using exemplary services running on exemplary virtual machines as may be agreed to under the exemplary bylaws. See, e.g., but not limited to FIG. 18, at element 1801.

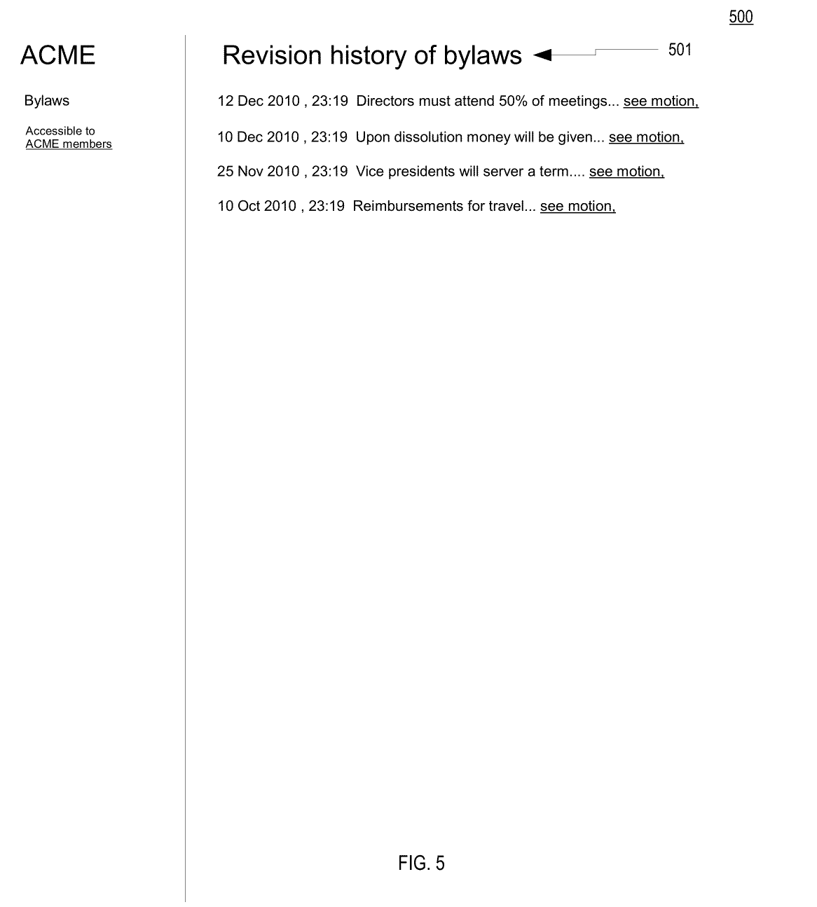

According to an exemplary embodiment, one exemplary purpose of collaboration may be creating an exemplary tracked history including, e.g., but not limited to, databases, documents, and/or document schemas, which may, in an exemplary embodiment, be organized into exemplary projects. According to an exemplary embodiment, the exemplary history of edits may include branches, where an exemplary single document may be edited along, e.g., but not limited to, an exemplary two different directions, and may, e.g., but not limited to, merge the two exemplary similar documents together. See, e.g., but not limited to FIG. 5, at element 501.

FIG. 1 depicts an exemplary diagram of an exemplary flow diagram illustrating exemplary general usage of an exemplary embodiment of the invention, according to an exemplary embodiment.

According to an exemplary embodiment, consider an exemplary environment regarding Health Insurance Portability and Accountability Act (HIPAA) 1996 statute's electronic data interchange (EDI) implementing regulations, now in a second major revision. The HIPAA EDI regulations describe an exemplary system of structured documents to be exchanged between one or more providers and one or more payers with healthcare information. Assume the US Department of Health and Human Services (DHHS) decides to an exemplary system, according to an exemplary embodiment of the present invention, such as, e.g., but not limited to, a DATAGROVE system or method available from Datagrove, Inc. of Media, Pa., USA, to manage development and administration of HIPAA EDI v3.

FIG. 1 illustrates flow diagram 100, which, according to an exemplary embodiment may begin with 102 and my continue immediately with 104.

In 104, according to an exemplary embodiment, for example, a government representative, or other user, may establish an account and may create an organization under an exemplary parliamentary set of rules, such as, e.g., but not limited to, under Robert's Rules of Order. In 104, according to an exemplary embodiment, one or more committees may be formed here, or elsewhere in diagram 100, and the system may provide automation, facilitation to incorporate committees into the organization's structure. Users may be added including, e.g., but not limited to, usernames, passwords, and/or other authentication information. According to an exemplary embodiment, at some time in the exemplary process 100, members may be invited, e.g., by email, etc., to access the exemplary system or method. From 104, diagram 100, may continue with 106.

In 106, according to an exemplary embodiment, the process of adoption of bylaws may be facilitated and/or automated. According to an exemplary embodiment, in 106, a user may be presented by the exemplary system or method with one or more checkbox(es), by which the user may adopt, e.g., but not limited to, boilerplate addendae to allow, e.g., but not limited to, electronic proceedings. According to an exemplary embodiment, a portable document format (PDF) document, or the like, may be created with the exemplary bylaws and may be reviewed and/or approved by legal counsel, for example. According to an exemplary embodiment, at some time in the exemplary process 100, members may be provided access, to the exemplary system or method, the exemplary electronic proceedings to gain access to the system, and/or the bylaws. From 106, diagram 100, may continue with 108.

In 108, according to an exemplary embodiment, the drafting of a standard may be automated and/or facilitated by a process which may include receiving a dataset, or receiving a selection of earlier prepared datasets or information. According to one exemplary embodiment, a technically savvy member may, e.g., but not limited to, contribute, e.g., exemplary standards, such as, e.g., but not limited to, an exemplary v2 specifications in the form of an exemplary, but non-limited EDI schema. From 108, diagram 100, may continue with 110.

In 110, according to an exemplary embodiment, a standard may be debated and/or the system or method may automate facilitating the process of debate, e.g., but not limited to, capturing dialogue, arguments for and/or against, building a historical record of the debate, etc. According to an exemplary embodiment, one or more committees may be formed. According to an exemplary embodiment, committees may be formed, e.g., but not limited to, to examine possible changes any of the transactions and/or to explore potential additional transactions, etc. From 110, flow diagram 100 may continue 112 to proceed to automation of adoption of the standard, or may proceed to 120, to further automate editing the standard, in advance of further debate in 110.

In 112, according to an exemplary embodiment, the process of adoption of the standard may be automated by the exemplary system or method. From 112, flow diagram 100 may continue with 114.

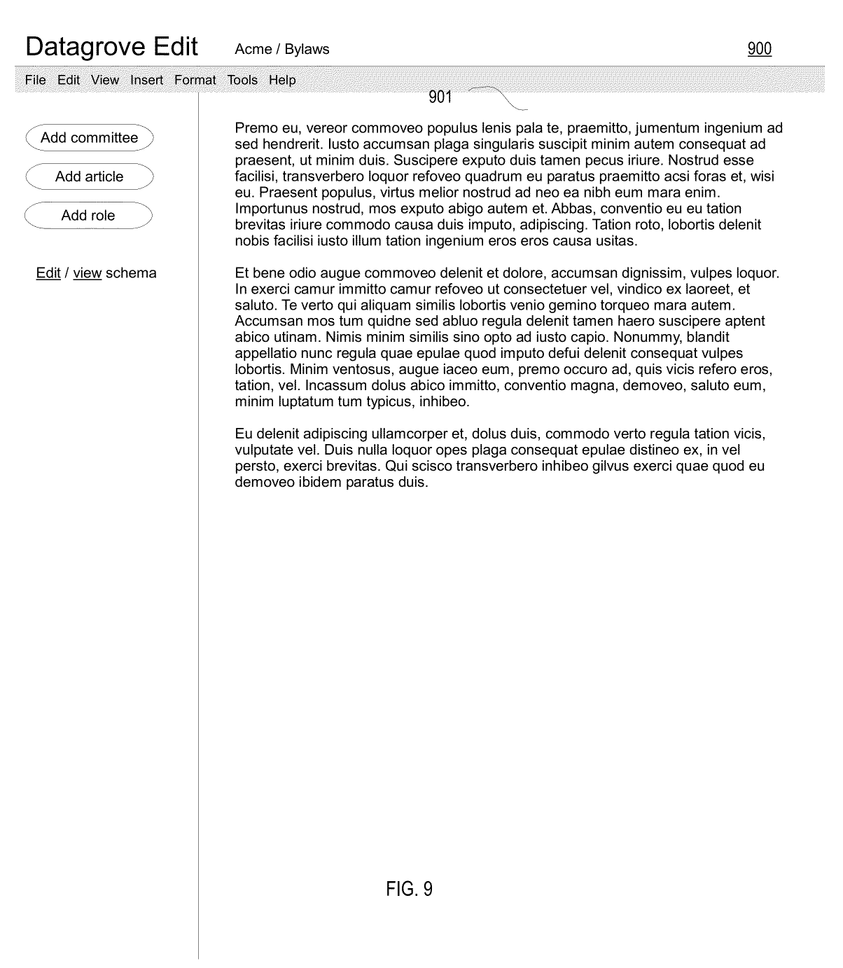

In 120, according to an exemplary embodiment, one or more committee members may edit the standard. According to an exemplary embodiment, with reference to 120 and FIG. 9, an exemplary v2 schema may, e.g., but not limited to, be edited (amended, modified, revised, addended, and/or deleted, etc.), including, e.g., but not limited to, receiving or enabling editing to create one or more new drafts, proposing an exemplary new draft for acceptance, and/or automating/facilitating a vote, and/or collecting results. According to an exemplary embodiment, approved edits may be collected into an evolving exemplary v3.

In 114, according to an exemplary embodiment, the process of disseminating the standard may be automated by the exemplary system or method. From 114, flow diagram 100 may continue with 116.

In 116, according to an exemplary embodiment, the process of enforcement of the standard may be automated by the exemplary system or method. From 116, flow diagram 100 may continue with 118.

In 118, according to an exemplary embodiment, the process 10 may determine whether the standard is to be edited further, and if so, flow diagram 100 may continue with 120, to automate facilitating further edit of the standard. If the standard is not to be edited further, according to one exemplary embodiment, the process may end with 122. In another exemplary embodiment, flow diagram 100 may not include 118 and the process from 116 may continue processing with 120 in the event of further editing of the standard.

According to an exemplary embodiment, some rules proposed by a committee may not be able to be reflected in the EDI schema directly. For example, there may be rules about, e.g., but not limited to, how line payments must balance claim payments. According to an exemplary embodiment, a member may, e.g., but not limited to, contribute an exemplary python program that may check the rule unreflected by the EDI schema, and may propose the rule; and the rule may in turn be accepted. According to an exemplary embodiment, the exemplary python program may run in a virtual machine, as is discussed further below with reference to 601 and FIG. 6, as, e.g., but not limited to, a web service, and the schema may directly reference the web service.

According to an exemplary embodiment, a transaction may be a valid transaction only if the web service returns a positive response. According to an exemplary embodiment, member users can use the extended schema to directly test their own transactions. According to an exemplary embodiment, an online editor of a system or method according to exemplary embodiments of the invention, such as, e.g., but not limited to, DATAGROVE's online editor, may allow one or more documents to be edited and/or validated to the specification in real-time and/or in near real-time as members, e.g., but not limited to, collaborate on issues using for example, but not limited to, an extensible structured editor 900 as discussed further below with reference to FIG. 9.

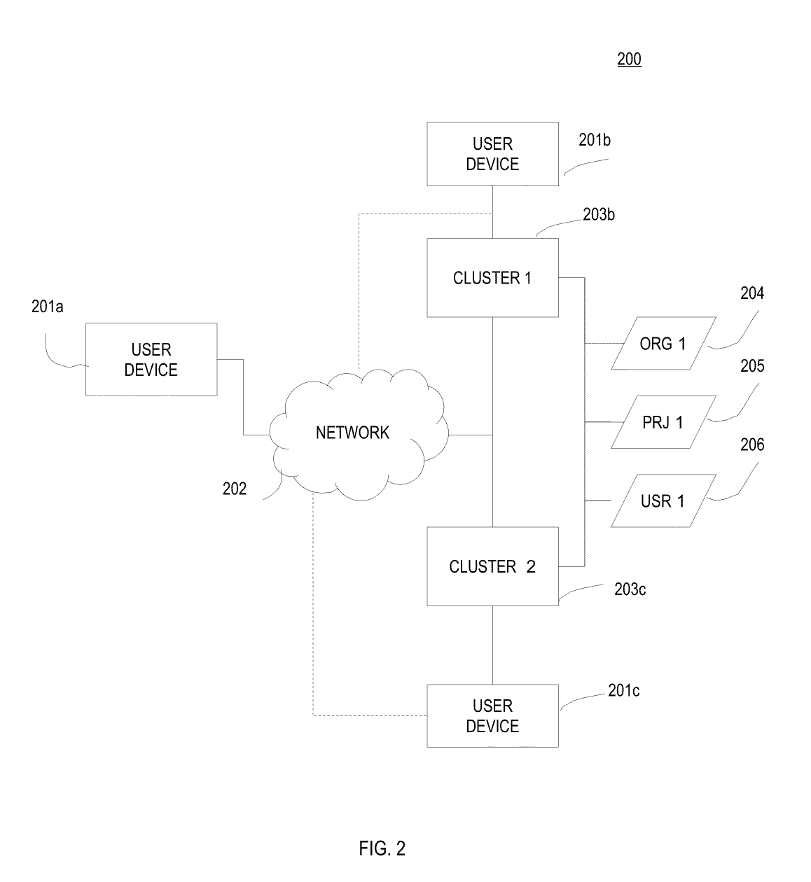

FIG. 2 depicts an exemplary typical hardware architecture configuration diagram 200 illustrating an exemplary system 200, as may be adapted to facilitate sharing of data through an exemplary inter-network or other network, according to an exemplary embodiment. According to an exemplary embodiment, user devices 201a, 201b, 201c (collectively referred to herein as 201) may be coupled to one another, directly, and/or indirectly, over exemplary connections and/or couplings, locally and/or remotely, over an exemplary network 202, as illustrated in an exemplary embodiment. According to an exemplary embodiment, a system, method and/or computer program product for implementing an exemplary embodiment may be provided and may further be directly/indirectly, coupled/connected, over connections/couplings, locally and/or remotely, over the network 202. The system according to an exemplary embodiment may be implemented in e.g., but not limited to, a cluster architecture, a peer-to-peer architecture, an application service provider (ASP) model architecture, a client-server architecture, a software as a service (SAAS) model, and/or a cloud computing model/architecture, etc. According to an exemplary embodiment, as shown in exemplary diagram 200, an exemplary cluster of user computing devices 203b, 203c (collectively 203) may be operative to or adapted to facilitate automation of creating, editing, forming an organization, and data representative of the organization and/or bylaws, and/or resolutions, etc. regarding, e.g., but not limited to, organization data (ORG 1) 204, project data (PRJ 1) 205, user data (USR 1) 206. According to an exemplary embodiment, the data may be inputted, created, stored, and/or outputted. According to an exemplary embodiment, user devices 201 may be coupled directly, or indirectly via e.g., network 202, to one or more of cluster devices 203b, 203c. Various additional components may be included in the system architecture 200 such as, e.g., but not limited to, load balancer(s), application server(s), web server(s), router(s), gateway(s), bridge(s), modem(s), network devices, network interface cards (NICs), physical layer components, data link layers components/software, network layer components/software, etc. Exemplary computing and/or communication devices as may be included in various exemplary embodiments may include devices as shown and described in further detail below with reference to FIG. 10. Any computing and/or communication device may include one or more processors and/or multi-core processors as will be apparent to those skilled in the art.

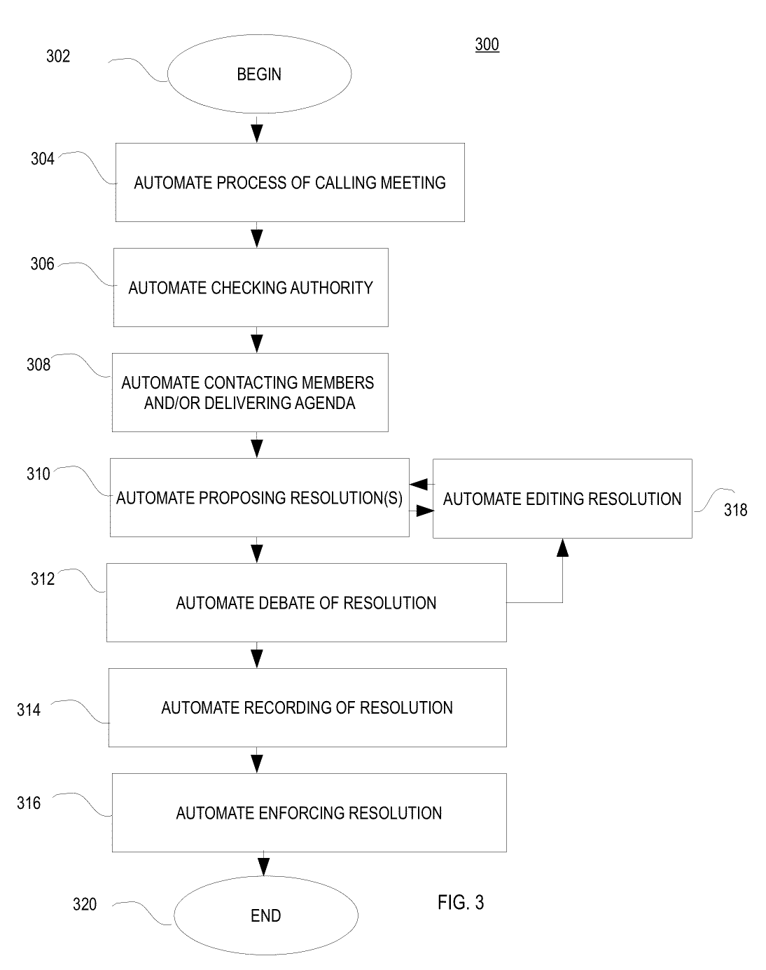

FIG. 3 depicts an exemplary diagram 300 of an exemplary process 300 for calling an exemplary meeting, according to an exemplary embodiment. According to an exemplary embodiment, flow diagram 300 may begin with 302 and may continue immediately with 304.

In 304, a process of calling a meeting may be automated and/or facilitated by a system and/or method according to an exemplary embodiment of the present invention. According to an exemplary embodiment, from 304, diagram 300 may continue with 306.

In 306, the system or method, according to an exemplary embodiment, may check authority, or automate and/or facilitate the checking of authority. According to an exemplary embodiment, from 306, diagram 300 may continue with 308.

In 308, the system or method, according to an exemplary embodiment, may contact members and/or deliver an agenda for the medium, and/or automate and/or facilitate the contact of members and/or the delivery of the agenda for the meeting. Such contact or delivery may use any of various well known messaging systems and/or methods including, e.g., but not limited to, electronic mail (email), short message system (SMS), multimedia message system (MMS), alert(s), notification(s), instant message(s), message(s), Twitter Tweet, Facebook message, post, chat, social media communication, web 2.0, etc. According to an exemplary embodiment, from 308, diagram 300 may continue with 310.

In 310, according to an exemplary embodiment, resolution(s) may be proposed and/or the system or method may automate facilitating the process of proposing resolutions, e.g., but not limited to, capturing a proposed resolution, the user proposing, the time of the proposal, among other information about the resolution(s), etc. According to an exemplary embodiment, from 310, flow diagram 300 may continue 312 to proceed to automate debate of the resolution, or may proceed to 318, to further automate editing the resolution(s), in advance of debate in 312.

In 312, according to an exemplary embodiment, the process of debating of the resolution(s) may be automated by the exemplary system or method. From 312, flow diagram 100 may continue with facilitating further editing of the resolution by proceeding to 318, or may proceed to recording of the resolution in 314.

In 318, according to an exemplary embodiment, one or more user(s) may edit the resolution(s). According to an exemplary embodiment, with reference to 318, a resolution may, e.g., but not limited to, be edited (amended, modified, revised, addended, and/or deleted, etc.), including, e.g., but not limited to, receiving or enabling editing to create one or more new drafts, proposing an exemplary new draft for acceptance, and/or automating/facilitating a vote, and/or collecting results. According to an exemplary embodiment, approved edits may be collected into an evolving resolution for proposal 310 and debate 312.

In 314, the system or method, according to an exemplary embodiment, may record the resolution, and/or automate and/or facilitate recording the resolution(s). According to an exemplary embodiment, from 314, diagram 300 may continue with 316.

In 316, the system or method, according to an exemplary embodiment, may enforce the resolution(s), and/or automate and/or facilitate enforcing the resolution(s). According to an exemplary embodiment, from 316, diagram 300 may continue with 320, where the flow diagram 300 may end according to an exemplary embodiment.

According to an exemplary embodiment, an exemplary organization internet business (IBZ), of an exemplary environment, such as, e.g., but not limited to, the exemplary architectural environment depicted in FIG. 2, may have many user/members, which may be actively participating in one way or another in the organization, and in particular, may have a virtual machine (VM), where the VM with a growing load of test activities may be becoming overburdened. According to an exemplary embodiment, suppose that the organization IBZ may decide that it desires to replicate the EDIv3 standard organization on a separate, and/or on the organization's own installation of the exemplary system and/or method of the exemplary DATAGROVE software system. According to an exemplary embodiment, suppose that the exemplary EDIv3 standard's members may pass a resolution to allow connection/coupling with the exemplary IBZ organization's replicated system and further that the IBZ organization's employed members can fully participate in the networked environment, e.g., through an exemplary server 203 of the IBZ organization. According to an exemplary embodiment, if IBZ organization's server becomes disconnected/decoupled, then messages may be held and may be synchronized according to an exemplary process, e.g., when a connection/coupling may be reestablished.

Suppose, according to an exemplary embodiment, another exemplary organization amazing web servers (AWS), may wish to curry favor with, e.g., influential members of the EDIv3 standard, and may offer a replicated service of the AWS organization, running on servers 203 of the AWS organization. The exemplary speedy VMs of the exemplary AWS organization may become a popular way of testing transactions against the emerging standard, according to an exemplary environment.

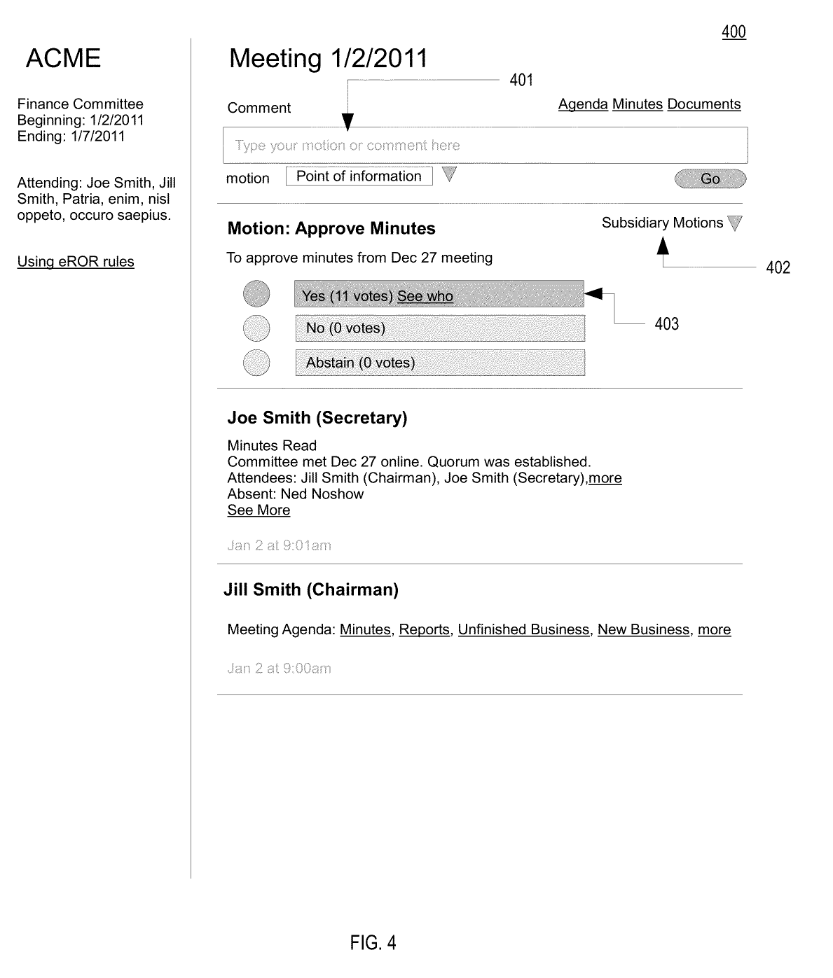

FIG. 4 depicts an exemplary screen depiction 400 of an exemplary user interface of an exemplary meeting, held on an exemplary January second day of 2011, according to an exemplary embodiment. The user interface may be implemented in e.g., but not limited to, a browser, an applet, or application, etc., According to exemplary embodiment, the user interface may include one or more portions or interface elements. In an exemplary interface, an element may include a meeting name, in the exemplary embodiment a date, an exemplary link to an agenda for the meeting, an exemplary link to minutes for the meeting, an exemplary link to documents associated with the meeting.

The organization name is listed, in the example case, ACME is the organization. The relevant group to which the given meeting pertains may be listed, in the exemplary embodiment, an exemplary finance committee may be included. In an exemplary embodiment, the time period overwhich the meeting shall be held may be provided. In the exemplary meeting as illustrated, a meeting may begin on an exemplary beginning date and/or time, in the example Jan. 2, 2011. As indicated in the exemplary depiction, an exemplary ending date may also be provided, in this case, Jan. 7, 2011, indicating an exemplary period of meeting(s) spanning multiple days. Another exemplary portion indicates a list of users attending the meeting, in the example users Joe Smith and Jill Smith are listed, among other examples. On the left portion of the interface it is indicated that electronic Roberts Rules of Order (eROR) are being used.

In an exemplary embodiment, a link to the rules of order being used may be provided, which may provide the selecting user additional information regarding the meeting's rules of order. Other examples of parliamentary systems or rules of order may include, in addition to the Roberts Rules of Order, the simplified system of the National Association of Parliamentarians (NAP), the Westminster system (often used in common law countries), a consensus system, an anarchic system, or other rules of order, etc. According to exemplary embodiments, the Roberts Rules of Order have several advantages over other systems. For further information on parliamentarian systems, one is directed for further information to the National Association of Parliamentarians®, whose webpage may be accessed at www.parliamentarians.org.

### Parliamentary Procedure

The National Association of Parliamentarians® notes that parliamentary procedure refers to rules of democracy—that is, the commonly accepted way in which a group of people come together, present and discuss possible courses of action, and make decisions. Parliamentary procedure is used by decision-making bodies such as, e.g., school boards, homeowners' associations, city councils, governmental entities, non-profit boards of directors, bar associations, etc. Parliamentary procedure defines duties people typically have when elected to an office of an organization, such as, e.g., the president, secretary, or treasurer of the organization. Fundamentally, parliamentary procedure defines how groups of people, no matter how formal or informal, can meet and make decisions effectively, in a fair, consistent manner and make efficient use of participants' time. Parliamentary principles help an organization hold more efficient meetings.

### Robert's Rules of Order Newly Revised

The most widely used parliamentary authority in the United States is Robert's Rules of Order Newly Revised (RONR), 10th edition (2000) (RONR) first published as the Pocket Manual of Rules of Order for Deliberative Assemblies in 1876. Since then, the book has been expanded and updated several times, incorporating solutions for countless meeting situations and acknowledging both societal and technological changes that affect the way business is conducted. RONR provides a summary of the benefit of parliamentary law to organizations: “The application of parliamentary law is the best method yet devised to enable assemblies of any size, with due regard for every member's opinion, to arrive at the general will on the maximum number of questions of varying complexity in a minimum time and under all kinds of internal climate ranging from total harmony to hardened or impassioned division of opinion.”

Parliamentary procedure is often used interchangeably with “parliamentary law,” and is more correctly defined as parliamentary law in combination with rules of order that a given assembly or organization has adopted. Parliamentary law is: a) rules of the game of democracy; b) rules that govern procedures by which civil and criminal laws are made and adopted; and c) rules and customs that govern deliberative and decision-making assemblies and organizations. The term rules of order (ROR) refers to written rules of parliamentary procedure formally adopted by a group of people or by an organization. These rules relate to the orderly transaction of business in meetings and to the duties of officers in facilitating the conduct of business. Written rules of order help ensure that the organization functions smoothly and that questions about procedure can be resolved quickly and fairly. An organization's rules of order may include bylaws, standing rules, policy manuals, and other rules. Objectives of Parliamentary procedure: a) establishes the purpose and structure of organizations; b) defines membership classifications, rights, and obligations; and c) defines rules and procedures for conducting business. Principles of Parliamentary law are based upon: a) the will of the majority; b) the right of the minority to be heard; c) protection of the rights of absentees; d) courtesy and justice for all; and e) consideration of one subject at a time.

### Deliberative Assemblies

Parliamentary procedure is generally applied to the meetings of deliberative assemblies per the NAP(R). A deliberative assembly has the following distinguishing characteristics: a) It is an independent or autonomous group of people meeting to determine, in full and free discussion, courses of action to be taken in the name of the entire group; b) The group is large enough—usually a dozen or more people—that a degree of formality is needed to make decisions efficiently; c) People having the right to participate (the members of the assembly) are generally free to act within the assembly according to their own judgment; d) In any decision made, the opinion of each member present has equal weight when voting; when a member votes, he or she joins others in assuming direct personal responsibility for the decision when voting on the prevailing side; e) If a member does not agree with the decision of the body, this does not constitute withdrawal from the body; and f) If there are absentee members—as there usually are—the members present at a regular or properly called meeting act on behalf of the entire membership, subject only to whatever limitations are established in the body's governing rules.

### Deliberative Assembly Types

The deliberative assembly may exist in many forms. Among the principal types are: a) mass meeting; b) local assembly of an organized society; c) convention; d) legislative body; and e) board.

The exemplary interface may include a comment field 401 as may include an exemplary free form text field, a motion descriptor selector, and an exemplary go button for entering the motion and/or comment from the comment field 401 into the meeting history area, which according to the exemplary illustrated embodiment may include a reverse chronological list of posts. The motion selector list may include, e.g., but not limited to, a user selectable pulldown list of possible motions, such as, e.g., but not limited to, point of information, point of order, move for adjournment, etc., Possible motions are dependent on the applicable parliamentary procedure chosen for the given meeting.

The logical operation of the use of main motions 401, or subsidiary motions 402 are dependent on the parliamentary rules of order, and may abide by Roberts Rules of Order, as revised, in an exemplary embodiment. A main motion is the basis of parliamentary procedure, and is used to introduce all business to be considered by a deliberative assembly. Main motions may only be considered if no other business is pending. A subsidiary motions is one that may be applied to another motion for the purpose of modifying the first motion, delaying action on the first motion, or disposing of the first motion. Privileged motions are motions unrelated to a current motion, but because of urgency/importance the privileged motions are considered immediately; these privileged motions are related to, e.g., members, the organization, and meeting procedure rather than the item of business being considered. Incidental motions are motions related to business being considered, but incidental motions do not modify the pending motion. Bring-back motions bring a question again before an assembly and are a special type of main motion permitting the assembly to consider business previously disposed of. The main motion, subsidiary motions, and privileged motions all are ranked relative to one another. The National Association of Parliamentarians illustrates the motions' rank and basic characteristics as follows:

| | Is it in | | | | | | | |
|---|---|---|---|---|---|---|---|---|
| | order when | Does it | | | What vote is | | | |
| | another has | require a | Is it | Is it | required for | May it be | | |
| Name of Motion | the floor? | second? | debatable? | amendable? | adoption? | reconsidered? | | |
| Fix the Time to Which to Adjourn* | No | Yes | No | Yes | M | Yes | | |
| Adjourn** | No | Yes | No | No | M | No | | |
| Recess* | No | Yes | No | Yes | M | No | {close oversize bracket} | PRIVILEGED |
| Raise a Question of Privilege | Yes | No | No | No | (1) | No | | |
| Call for the Orders of the Day | Yes | No | No | No | (2) | No | | |
| Lay on the Table | No | Yes | No | No | M | No | | |
| Previous Question | No | Yes | No | No | ⅔ | Yes | | |
| Limit or Extend Limits of Debate | No | Yes | No | Yes | ⅔ | (3) | | |
| Postpone to a Certain Time (Definitely) | No | Yes | Yes | Yes | M (4) | Yes | {close oversize bracket} | SUBSIDIARY |
| Commit (Refer to a Committee) | No | Yes | Yes | Yes | M | (5) | | |
| Amend | No | Yes | (6) | Yes | M | Yes | | |
| Postpone Indefinitely | No | Yes | Yes | No | M | (7) | | |
| Main Motion | No | Yes | Yes | Yes | M | Yes | | |

Based on Robert's Rules of Order Newly Revised (RONR)
*A main motion if made when no business pending
**Check RONR for specific rules
(1) Chair grants
(2) No vote: demand
(3) Yes, the unexecuted part may be reconsidered
(4) ⅔ vote required if made a special order
(5) Yes, if the committee has not started work
(6) Yes, if applied to a debatable motion
(7) Only an affirmative vote may be reconsidered

In an exemplary embodiment, the latest event occurring in a given meeting may be presented first in order. In another, alternative exemplary embodiment, the order of the meeting may instead be chronological. The exemplary illustrated reverse chronological list of FIG. 4, includes, in the exemplary embodiment, a first exemplary list item or post of a user, Jill Smith, whose name, and/or user identifier, or other indication (e.g., but not limited to, username, email address, etc.) may be shown, and an exemplary title, in the example, chairman, may be included to indicate if the comment is being made by a member, a committee member, a chairperson, officer, etc. Especially in an open meeting environment, there may be provided an ability to filter and/or limit the amount of information shown on the meeting. In the example, the first list item indicates that the chairman of the meeting, Jill Smith posted a copy of the meeting agenda with specific linked items, including, e.g., but not limited to, minutes, reports, unfinished business, new business, and more. The posting is date and time stamped to indicate the exemplary chronology.

As illustrated in FIG. 4, a second item or post may be provided by a second user, Joe Smith, who is shown in the exemplary embodiment as acting in the role as Secretary. As shown, the time of his comment or motion is indicated, in this case he has entered a motion to approve the minutes of a previous meeting of December 27, and voting buttons 403 have been provided, as well as reflecting the results of the vote, in this case in the form of a colored bar, but could also be a bar of length indicating the leading votes, or other numerical, and/or graphical indication, or color to indicate the vote choices, as well as vote results. As shown, one may select to see who has voted for what choice.

Suppose in an exemplary embodiment that an exemplary organization IBZ may discover a bug or issue to be edited in the exemplary Python test code, may edit, using an exemplary system or method as depicted in and discussed in 120, and further below with reference to FIG. 9 according to an exemplary embodiment, and may submit a patch, and may propose a new version including the edits to replace the old. The exemplary new version may then be voted upon using an exemplary system or method as depicted in and discussed further with reference to FIG. 4 according to an exemplary embodiment, and suppose the edits are approved by the vote, in the example. According to an exemplary embodiment, the standard may be disseminated as in 114, to exemplary replicated systems, which may, in an exemplary embodiment, be automatically updated installing the new version, e.g., instantly, as soon as a quorum vote may be achieved.

FIG. 5 depicts an exemplary screen depiction 501 of an exemplary user interface illustrating an exemplary document history screen, indicating an exemplary historical list of revisions of bylaws in an exemplary reverse chronological listing, according to an exemplary embodiment. As indicated in an exemplary embodiment, a brief entry may be provided for each historical event listed. In an exemplary embodiment, for each entry or record, a plurality of fields may be provided including, e.g., but not limited to, an exemplary date of a revision or edit, an exemplary time of entry, an exemplary brief description and/or an exemplary summary and/or an exemplary title. For each entry a link may be provided to the associated motion/revision to which the entry/record refers. The data records including various fields, may be part of a database, and the history may include user selectable and/or customizable field selections, which may be chosen, and/or used for sorting the list (not shown). According to an exemplary embodiment, accessibility to the revision history and/or the bylaws themselves may be provided, and/or filtered/limited by user type, such as, e.g., members only, etc. User selection of the “see motion” link/field for a given entry/record may allow loading/providing user access to the meeting during which a given bylaw was adopted. Documents may include such information as results of a comparison between two versions of a document. According to an exemplary embodiment, a three way merge such as a so-called DIFF/MATCH/PATCH may be used. According to an exemplary embodiment, so-called “diffs” may be obtained, including a difference between two documents. A so-called match, indicating where to make the change may be provided. Finally, an exemplary patch may be provided for merging the results. In an exemplary embodiment, if a first version of a bylaw has dues of “$50 dues for a member” and a second version of dues of “$75 dues for a member” the diff would be 50 to 75, the match would be the location, after the $, and before dues, and the patch, would be the merge of the 75 replacing the 50. In an exemplary embodiment, only certain things may be made editable, such as, e.g., but not limited to, bylaws may be changed, but minutes, for example, may not be editable for historical purposes, for example.

FIG. 6 depicts an exemplary screen depiction 600 of an exemplary user interface illustrating an exemplary project home screen, according to an exemplary embodiment.

Exemplary links may be made available for user selection by displaying, e.g., but not limited to, graphical icons and/or text, for such things as a list of all files in the form of an exemplary directory tree, which may be viewed for an entire organization. In the exemplary embodiment, organization ACME may have a list of projects that may be accessed, and certain projects, for example, may only be accessible by certain committee member, or other access levels, as user selectable and/or customizable. A 601, allows a user to select a virtual machines directory, according to an example described in further detail below. An exemplary link 602 may be used to clone a previous project, to use a first project or file to clone the prior project, to make changes and then using an exemplary 3-way merger (DIFF/MATCH/PATCH), the changes may be merged. For example, according to an exemplary embodiment, two groups could break off and work in parallel and their work could then be merged using such an example merge process. Since all files are given a path, all files may be linked to an/or accessed by drilling down by user selection through the directory structures. A brief summary or excerpt of a given file or project may be previewed at the bottom portion in one exemplary embodiment, and user selection may bring up additional details. In an exemplary embodiment, the entire organization may be a directory tree, or branch in the tree. An exemplary issue tracker link may provide a link to a list of events relating to a particular issue for which a given user wishes to track changes, for example.

According to an exemplary embodiment, an exemplary standard EDIv3 organization may decide that it needs to seek more public comment, so the exemplary standard organization may tag a current schema and test code exemplary version A1 and may announce the exemplary version to the public. Access to this exemplary version A1 may be made anonymous, using for example, but not limited to, the system or method as described further with reference to 603 in FIG. 6 (e.g., by making it accessible to only certain groups, or changing access to anyone, or otherwise), or so that, e.g., anyone can use it. Meanwhile work may continue on exemplary version A2.

According to an exemplary embodiment, an exemplary original bylaw may only allow members to participate in organization discussions, for an exemplary organization. According to an exemplary embodiment, an exemplary boilerplate modification may be proposed to the exemplary organization's membership to open a forum to public discussion beyond only members. If the modification to the bylaws passes, then in an exemplary embodiment, the forum may be made accessible, e.g., but not limited to, immediately, upon, e.g., but not limited to, the final quorum vote.

According to an exemplary embodiment, an exemplary, the ensuing exemplary public discussions may become, e.g., very heated and may become hard to follow, so the exemplary IBZ organization may propose an exemplary, but nonlimiting Javascript, or other, widget, or application program, to, e.g., but not limited to, add to the discussion room that may, e.g., highlight just the member comments and/or additional companies, which may be selected by the viewer, or other user. According to an exemplary embodiment, an exemplary widget may be approved by the membership (using e.g., a system as shown in FIG. 6), an may, in an exemplary embodiment, be instantly made available in, e.g., but not limited to, every member's web or other user interface. According to an exemplary embodiment, an exemplary editor extension project, may be added to facilitate editing documents in the exemplary new EDIv3 formats.

According to an exemplary embodiment, after much development, testing, and debate, an exemplary EDIv3 standard group may vote (using e.g., a system as shown in FIG. 6), e.g., to adopt the standard for official use and in an exemplary embodiment may begin being used for production transactions. According to an exemplary embodiment, a small number of errata may be discovered, exemplary amendments proposed, and may be adopted. According to an exemplary embodiment, the exemplary EDIv3 standard organization may want to give time for companies to implement the errata, and may schedule the newly approved errata to take effect, some period or point in time in the future, e.g., but not limited to, six months in the future.

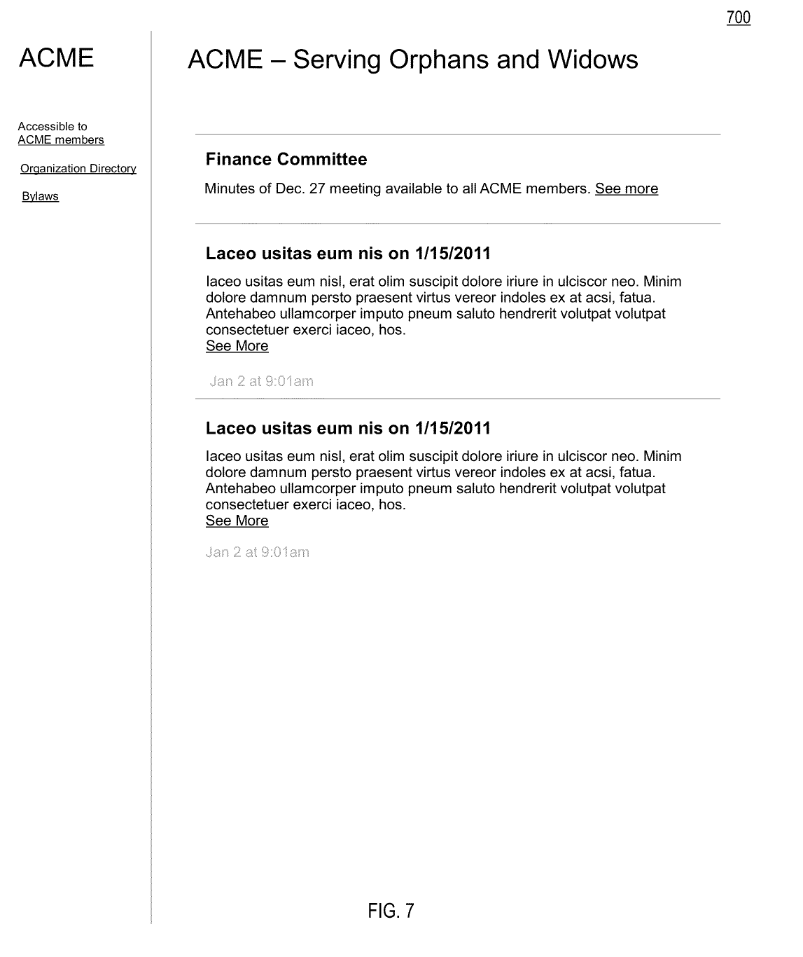

FIG. 7 depicts an exemplary screen depiction 700 of an exemplary user interface illustrating an exemplary organization home screen, according to an exemplary embodiment. In the exemplary embodiment, an exemplary organization name, title, or logo, “ACME—Serving Orphans and Widows” may be provided at the top of the organization announcement page. A List of Announcements for the organization may be provided in chronological and/or reverse chronological order, and an excerpt/summary may be provided, as well as various other fields of a given record, such as, e.g., a title for a given news item, a date and/or time, a link for access to further details. An announcement page may be provided as shown for a given organization. An announcement page may also be provided for a given user or person. Other links may be provided such as, e.g. but not limited to, access controls, as to whom may access the information, and links to customize access. If access to an organizational chart is permitted, a link to an org chart may be provided as illustrated in the exemplary embodiment. Other links such as, e.g., a link to the organization's bylaws, etc., may also be included.

FIG. 8 depicts an exemplary screen depiction 800 of an exemplary user interface illustrating an exemplary system user home screen, according to an exemplary embodiment.

According to an exemplary embodiment, a list of multiple processes of relevance to the selected individual user's page may be provided. Thus, in the exemplary embodiment, the user, John Doe may have an exemplary newsfeed 801, which may list, in the exemplary embodiment, in reverse chronological order, or in chronological order, a list of any events or processes of relevance to the given person. According to an exemplary embodiment, an exemplary user, John Doe, a member of the exemplary EDIv3 organization, may be also asked to participate in defining an exemplary new XML standard for another standards committee using, e.g., but not limited a system like the exemplary system or method according to the exemplary embodiment of the invention, such as, e.g., available from DATAGROVE. When the exemplary user John Doe logs into DATAGROVE the exemplary user may be presented an exemplary news feed 801, (such as, e.g., a system or method as illustrated in FIG. 8), which may combine, in an exemplary embodiment, updates from one, or more than one organizations and/or committees, (in this case both the exemplary EDIv3 organization activity and the exemplary member user John Doe's other exemplary new XML standard for the other standards committee's group activity. According to an exemplary embodiment, the exemplary member user John Doe, may be given user interface elements, such as, e.g., user selectable profile elements, or time related (e.g., recency), which may be used to, e.g., but not limited to, control and/or filter the contents of the user's news feed by, e.g., upgrading and/or blocking notifications related to, e.g., but not limited to, a person or people, committee(s), organization(s), and/or upcoming vote(s). Actions like voting can be accomplished directly within the context of the news feed, or John can follow a link to a page dedicated to the action. John can express his current opinion on the vote through comments without actually entering a vote [401]. He can explore the votes [403] and leanings of colleagues and inquire of them or attempt to persuade them directly.

According to an exemplary embodiment, the exemplary member user John Doe, as illustrated in FIG. 8, may control accessibility to the newsfeed. According to an exemplary embodiment, the exemplary member user John Doe, as illustrated in FIG. 8, may have access to organizations for which the user is a member by selecting an exemplary organizations link. According to an exemplary embodiment, the exemplary member user John Doe, as illustrated in FIG. 8, may select to create a new organization for the user by selecting an exemplary create new organizations link. According to an exemplary embodiment, the exemplary member user John Doe, as illustrated in FIG. 8, may edit the user's profile by selecting an exemplary edit profile link, which may allow the user to edit/customize settings relating to the user's specific preferences, data, identifying information, passwords, contact information, etc. According to an exemplary embodiment, the exemplary member user John Doe, as illustrated in FIG. 8, may have access to a list of any upcoming meetings, and/or recent projects, upon which the user has previously worked.

FIG. 9 depicts an exemplary screen depiction 900 of an exemplary extensible structured editor, according to an exemplary embodiment. According to an exemplary embodiment, user interface 900 may include interface elements enabling adding a committee, adding an article, adding a role, edit and/or viewing a schema. Standard wordprocessing menus may be included including such menu elements as provided in Microsoft Office and Microsoft Word in particular, and/or the menu items of openoffice.org Writer, as are well known to those skilled in the relevant art. In an exemplary embodiment, the editor may be a what you see is what you get (WYSIWYG) editor. The document to be edited may appear in document portion 901.

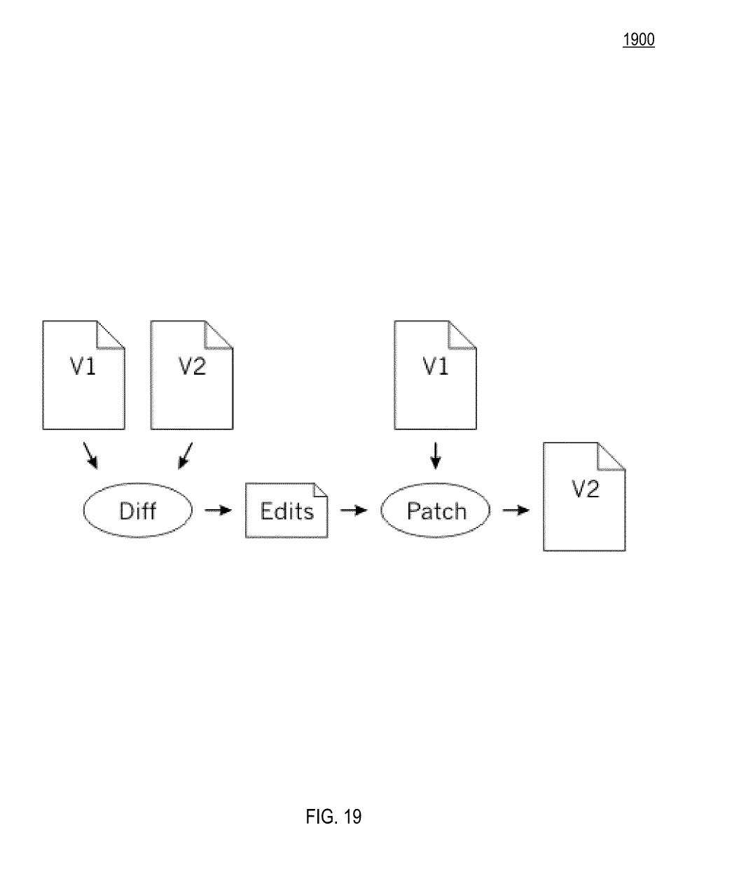

FIG. 19 illustrates an exemplary diff and patch. According to an exemplary embodiment, live updates to edit may be accomplished using, e.g., but not limited to, diff and smart patch as well known, and as described, e.g., but not limited to, http://neil.fraser.name/writing/patch/. In particular, patch is the process of modifying a document based on a set of edits created by a difference algorithm. A typical use case would be a developer who creates a new version of a document, uses diff to create a set of edits, then transmits those edits to a customer, the customer then applies the edits to the customer's version of the document, thus recreating the new version. A strict patch program is a straight forward piece of software. It executes a scripted set of insertions and deletions on one version of the document to produce the other version. Assuming that both copies of the base document (in the above case labeled ‘V1’) are identical, then both copies of the second document (in the above case labeled ‘V2’) will also be identical. However, the program becomes more complicated when the two copies of the base document are not identical. In these cases the patch program must do the best job it can in applying the edits to the correct locations.

Diff Strategies, by Neil Fraser, April 2006, notes, “Computing the differences between two sequences is at the core of many applications. Below is a simple example of the difference between two texts:
Text 1: Apples are a fruit.
Text 2: Bananas are also fruit.
Diff: Bananas are also fruit.

Difference algorithms [may include] pre-processing optimizations [ ] and post-processing cleanup.”

Diffing and patching are driven by heuristics that take into account the nature of the content. According to an exemplary embodiment, Datagrove may provide some heuristics for general text and XML processing, but these heuristics can be redefined based on the document schema, according to an exemplary embodiment. According to an exemplary embodiment, as new document types are defined, the diff and patch algorithms may be added to the project defining the document type.

According to an exemplary embodiment, different organizational contexts may often engender different choices of computer programming languages. A hypervisor approach, according to an exemplary embodiment, may supports the widest range of choices. According to an exemplary embodiment, the exemplary hypervisor approach, unlike previous cluster based hypervisor systems such as, e.g., but not limited to, Amazon Elastic Compute Cloud (Amazon EC2), available from amazon.com of Seattle, Wash., USA and Eucalyptus available from www.eucalyptus.com, Eucalyptus Systems, Inc., 6755 Hollister Avenue, Goleta, Calif. 93117, according to an exemplary embodiment, an exemplary process as set forth herein, such as the Datagrove system and/or method may allow building a virtual machine through a parliamentary collaboration, revision control of the change history of the machine, and adoption by appropriate voting rules.

According to an exemplary embodiment, structured document languages—available from Datagrove, according to an exemplary embodiment may incorporate special support for EDI dialects, XML (document type definition (DTD), XML schema definition (XSD), regular language for XML next generation (Relax NG) schema language, darwin information typing architecture (DITA), universal business language(UBL)), structured forms, and a structured bylaw schema available from Datagrove of Media, Pa. Despite the powerful abilities to describe documents in a schema language such as Relax NG, these schema languages are not Turing complete, and so there is often a need to describe additional rules in external code. The present invention, according to an exemplary embodiment, may allow an additional validation step to be defined in the document validation interface; when this interface is provided for a document type, the system validation will take advantage of it. According to an exemplary embodiment, the additional validation step may effectively extend all schema languages to Turing complete, while still staying in the same transactional document control system.

According to an exemplary embodiment, widely used interfaces endemically may create a tension between making an interface that is custom to the user's need, but if everyone creates a unique proprietary interface, support can become unwieldy. According to an exemplary embodiment, the present invention may allow a consensus to be built for shared activities such as meeting and document editing. According to an exemplary embodiment, the consensus may allow users to collaborate not just on documents, but on the interface used to edit the documents. This may minimize support costs by creating a shared core of user interface functionality.

According to an exemplary embodiment, since most of the actions of each group happen within the context of the DATAGROVE interface, according to an exemplary embodiment, a complete picture of the group dynamics as it evolves, may be provided. For example one can identify consistent allies and opponents, leaders and followers, according to an exemplary embodiment. According to an exemplary embodiment, data may be stored in an exemplary structured query language (SQL) relational database and/or in a distributed file system. According to an exemplary embodiment, the metadata for the file system may be kept in the SQL database so that the metadata and the data can be controlled in the same transaction. According to an exemplary embodiment, the availability of this data, or its unavailability, can be set in the bylaws, or delegated by the bylaws to general resolution or special committee.

### Exemplary Democratic Database (DDB)

### INTRODUCTION

Databases have long been bastions of autocracy where the database administrator (DBA) makes all the rules and governs with complete authority. And although databases are primarily tasked with storing data, modern databases still forget more than they remember since new data is constantly replacing the old. Any DBA can rewrite history with impunity and leave no trail of evidence. In return for these compromises, databases are fast, efficient, and easy to use.

Public governance, on the other hand, has developed sophisticated systems for dividing power in practical ways. Parliamentary procedure provides methods for groups to work together to achieve a common purpose without resorting to autocracy. The Library of Congress maintains comprehensive records indefinitely, which is a protection against people rewriting history. Unfortunately the process tends to be not terribly efficient and at times can be downright tedious. An exemplary democratic database, according to an exemplary embodiment of the present invention, may combine the features of databases with those of public governance.

There is no all powerful DBA required; ownership of data may be shared equally among group members, according to an exemplary embodiment. No data is forgotten; thanks to decreased costs of inexpensive storage devices it is now practical to build a database system that may retain a history of all changes, according to an exemplary embodiment. Such exemplary demographic databases may be easy to use. A database may be used to modernize both data storage and/or public governance, according to an exemplary embodiment.

### Roles and Rules of Order

Roles can be used to represent the privilege of membership in an organization, according to an exemplary embodiment. Using roles, according to an exemplary embodiment, members of an organization can own database objects and update them corporately. The membership can agree to govern themselves under rules of order, according to an exemplary embodiment. The rules of order, according to an exemplary embodiment, can be conventional parliamentary procedures (e.g., but not limited to, Roberts Rules of Order, etc.) or customized to particular needs of the group, according to another exemplary embodiment.

create role finance_committee_member rules roberts_rules;
grant finance_committee_member to john_doe;
grant owner on finance_committee to finance_committee_members;
-- at this point schema finance_committee is in the hands of its members
-- changes to the tables in the schema can only be committed by vote

### Motions and Voting

After a membership role is assigned rules of order, according to an exemplary embodiment, changes to objects owned by the role can then, according to an exemplary embodiment, be only made in accordance with those rules.

using finance_committee;
-- a live meeting must establish a quorum
-- a roll call establishes the quorum according to the rules of order
-- this may not require anything, or may require advanced authentication
-- like a two factor key or biometrics.
motion roll_call finance_committee_members;
motion adjourn as adjourn1
motion second to adjourn1
vote yes to adjourn1;
-- any valid command can entered as a motion, if it is adopted, then it
is executed
-- this is the only way to execute an update command directly against a
schema protected by -
- rules of order
motion sql(alter table some_table rename to some_other_name) as
rename_table ;

According to one exemplary embodiment, there can be at most one meeting per role at any given time. Motions that are out of order, according to an exemplary embodiment, may be held for a time specified in the rules, at which point the user entering the motion may receive an error message, generated by the system, method and/or computer program product, according to an exemplary embodiment.

### Elections

Offices, according to an exemplary embodiment, may correspond to a grant of a role, thus being elected to an office may carry with the office a grant of that role and corresponding database privileges associated therewith.

nominate john_doe for finance_committe_member.chairman;
motion elect chairman at(now for one year) as ec1;
vote john_doe to ec1;

### Proxy

Making motions and voting by proxy, according to an exemplary embodiment, may allow the software, or a proxied delegate, to act on a user's behalf at one or more meeting(s). According to an exemplary embodiment, Proxies may even call a meeting that may be attended by no one but proxies! Not all organizations allow proxies and/or proxy meetings. The usage of proxies may controlled by the rules of order, according to an exemplary embodiment.

Proxy meetings, according to an exemplary embodiment, may be held whenever there are enough votes for a particular motion for the motion to carry, according to an exemplary embodiment.

motion by proxy adopt dues_increase;
vote by proxy yes to dues_increase;

### Schemas and Proposals

Schemas, according to an exemplary embodiment, may serve an expanded role in an exemplary demographic database (DDB), according to an exemplary embodiment. Exemplary schemas may be the basis for tracking changes, branching, and/or merging, etc. By default schemas may be defined as “partially persistent”, i.e., one can query any point in the schema's edit history but one may only change the newest version (http://en.wikipedia.org/wiki/Persistent_data_structure), according to an exemplary embodiment. The history may be optional, though, and can be omitted for, e.g., but not limited to, performance and/or security reasons, etc.

Each schema may have a base schema (thus the database can be viewed as a forest of schemas), according to an exemplary embodiment. A schema with a base schema may be called a “proposal,” according to an exemplary embodiment. Each schema, according to an exemplary embodiment, may be viewed, combined with its based schema (aka “folded”), and/or independently (“unfolded”). Folding may combine schemas according to the following rules, according to an exemplary embodiment:

1) Tables may be folded if they have the same name and same primary key, according to an exemplary embodiment.

2) A folded table may use an outer join of the base and proposal, where same attributes with the same name and type may be folded into one attribute, according to an exemplary embodiment.

3) A folded attribute may use a type specific algorithm to combine the base value with the proposed value, according to an exemplary embodiment. The simplest and most common algorithm “overwrite” may be to take the proposed attribute if non-null, and the base otherwise, according to an exemplary embodiment. Various merge algorithms, according to an exemplary embodiment, may be employed to combine the proposal and/or base. One algorithm “weave” is described in detail later in this document, according to an exemplary embodiment.

4) Every tuple may have a boolean attribute “deleted” that may be folded according to #3, according to an exemplary embodiment.

The rules may be followed recursively; the base schema may itself have a base schema, and so on, back to a schema with no base, according to an exemplary embodiment.

A proposal can be adopted, according to an exemplary embodiment, if its base schema is updatable, which then may merge it into its base schema, according to an exemplary embodiment. An adopted proposal may then become read only and part of the history of the base schema, according to an exemplary embodiment; the proposal may be dropped and the name re-used, according to an exemplary embodiment. A proposal schema, according to an exemplary embodiment, based on a point in another schema's history cannot be adopted because the history of that schema cannot be modified, according to an exemplary embodiment.

-- create a new patching schema
-- because we don't fix a time for the base schema, querying
dues_increase
-- will continue to see changes made in finance_committee as well as
dues_increase
create schema dues_increase from finance_committee;
-- change the patch
update dues_increase.member_options
set dues=100;
-- apply the patch to the underlying database
adopt dues_increase;
drop schema dues_increase;
-- rather than track changes in the underlying schema you can fix
it a point in time.
-- You can also use this to tag older versions or fork the schema into
alternate paths create schema version1_0 from finance_committee(now);
-- you can still create schemas with no history tracking
create schema no_tracking history none;
-- modify a remote database using a proposal created on the local database.
create schema finance_committee
remote(10.1.2.5:4092/masterdb/finance_committee);
create schema dues_increase from finance_committee;
update dues_increase.member_options set dues=100;
-- this will be adopted on the master, with the resulting updates then
-- synchronized with the client.
adopt dues_increase;

Proposals, according to an exemplary embodiment, can be built on other proposals, according to an exemplary embodiment. For example, a complex proposal might be built by several teams and then may be adopted into, or on acoordinated proposal that may itself then be adopted into the underlying schema, according to an exemplary embodiment.

### Collaborative Data Types (CDTs)

CDTs, according to an exemplary embodiment, may allow multiple users to collaborate in real time to edit the same document, according to an exemplary embodiment. The source for the weave CDT may be provided as an appendix, according to an exemplary embodiment. Users may create their own collaborative data types, according to an exemplary embodiment, on the same infrastructure using a variety of programming languages, according to an exemplary embodiment.

-- to open a CDT for live editing use open(attribute,marker[,start][,size])
select open(data,‘xfilestream’)
from sysfiles where path=‘/xfiles.txt’;
-- data will come in messages with a class tag that matches the marker
-- e.g. xfilestream|...type specific data blob...
-- update data using the stored procedure update and the handle
call update(‘xfilestream’,‘...type specific data blob...’);
-- it's good manners to call close when you are done
call close(‘xfilestream’)

CDTs may provide, according to an exemplary embodiment, their own support for partial persistency and/or folding, according to an exemplary embodiment. The CDT can take advantage of support already in the database, and/or implement its own (which may be more efficient for its data type), according to an exemplary embodiment. Special support may be provided for data types which can be modified by writing to the end of a log (e.g, any functional data structure can be trivially implemented this way), according to an exemplary embodiment.

A fold operation may combine the values from multiple fields: using, e.g., but not limited to, one from a base schema and one from each layer of proposal on top of that, etc., according to an exemplary embodiment. The default for built in types may be to take the top level proposal schema value and/or ignore everything else, according to an exemplary embodiment.

### Weave

Weave, according to an exemplary embodiment may be a text based CDT provided for collaboratively editing text values, according to an exemplary embodiment. Two exemplary users can edit the same value simultaneously and their edits may be merged in a consistent manner similar to what people expect from operation transformation based applications like google docs, according to an exemplary embodiment.

The weave type may also merge the data during folding, according to an exemplary embodiment. The effect may be similar to the quilt patching tool, according to an exemplary embodiment. The proposal may build a patch that may be continuously integrated with the base value, according to an exemplary embodiment. If one user is editing the base schema value, and another is editing the same value in a proposal, the proposal editor may see the changes of the base editor, but the base schema editor may not see the changes by the proposal editor, according to an exemplary embodiment.

Like causal trees (http://bouillon.math.usu.ru/articles/broth5.pdf), according to an exemplary embodiment, a unique identification may be assigned to each symbol, and the “cause” of the symbol may be tracked as its immediately preceding symbol, according to an exemplary embodiment. Folding multiple schemas together may be managed by a pre-order depth first search of the causal tree, siblings may be visited according to the fold order, according to an exemplary embodiment.

Unlike causal trees, a log need not be dedicated to each concurrent editing session, according to an exemplary embodiment. This may have various positive and/or negative ramifications, according to an exemplary embodiment. There is no issue with running out of thread ids, according to an exemplary embodiment, but because the log may be being built concurrently by multiple users, one may lose the nice property that the id may be fully assigned by the client generating the symbol, according to an exemplary embodiment. Instead, the client, according to an exemplary embodiment, must receive the id assignments from database server. This may be a modest complication in the client software that may simplify exemplary server operation, according to an exemplary embodiment.

A weakness of causal trees may be that if two editors concurrently make the same change, it may be duplicated in the merged text, according to one exemplary embodiment. To handle the case where multiple related schemas make the same change, one may automatically delete the matching prefix of sibling strings, according to an exemplary embodiment. When a proposal is adopted, the symbol tree in the proposal may be deactivated (i.e., no longer be used to create the merged text), according to an exemplary embodiment.

Internally weaves may be broken into blocks which may represent linear sections of the file, according to an exemplary embodiment. Blocks may be reordered (also using causal trees), according to an exemplary embodiment. Each block may be independent, according to an exemplary embodiment; i.e., no causal dependencies are tracked between blocks, according to an exemplary embodiment.

Rebasing a weave may be easy and/or effective if the proposal weave and new base share a significant common ancestor (as is typically the case), according to an exemplary embodiment. All the values between the proposal and the common ancestor may be appended together into a single log (causal pointers are renumbered), according to an exemplary embodiment, and the base may be reset, according to an exemplary embodiment. Rebasing a weave to a value where there is no common ancestor (i.e. the only common ancestor is the null string) may result in the proposal value and/or the base value being appended together, according to an exemplary embodiment.

-- get up to 10,000 units of weave
-- receive messages when ever that section of the weave is modified by
-- some|one else
select open(v,‘#temp123’,0,10000) from sample with update;
-- update the weave using a handle and some changes
call update(93485,‘aa5tb6’);

Weaves may allow fast full text searches, according to an exemplary embodiment.

select * from some_table where content match ‘tutorial’;

User defined tables may incorporate weave types, according to an exemplary embodiment.

create table user_table ( path text, data weave);
insert into user_table(path,data[type]) values(‘untitled’,‘text/plain’);
select data from user_table where path=‘untitled’;

### Files

Each schema may have files associated with the schema, according to an exemplary embodiment, using a conventional hierarchical path syntax, according to an exemplary embodiment.

-- sys is a system schema that allows access to files outside the database
copy sys.‘http://localhost/file/file.txt’ ‘file.txt’;

Text based files may be simply weaves stored in the table sysfile, according to an exemplary embodiment. Every schema may contain a sysfile table, according to an exemplary embodiment. The combination of weaves and/or database versioning may allow change tracking with attribution of the user making the change, similar to a source control system like git, according to an exemplary embodiment.

Text based files can be edited with an editor that may provide real time collaborative editing (based on weaves) similar to Google Docs, according to an exemplary embodiment. Alternatively, a user may elect to use their own text editor, according to an exemplary embodiment. In this case, a diff engine may run when the document is saved to compute the changes made during the editing session, according to an exemplary embodiment, then this change may be applied as if made using the online editor, according to an exemplary embodiment.

Binary files can also be stored as a typical database blob, according to an exemplary embodiment. This may work with the snapshot support to preserve the history of changes to binary files, according to an exemplary embodiment.

### Change History

At different times a user may need to compare two schemas for differences, according to an exemplary embodiment. Diff is a table function that may take two schemas as arguments and may return a table with the differences, according to an exemplary embodiment.

-- see changes being proposed in dues_increase
select * from diff(dues_increase,finance_committee);
-- see changes from one year ago
select * from
diff(finance_committee,finance_committee(dateadd(year,−1,now( )));

### Messages

Full clients, according to an exemplary embodiment, may be prepared to accept messages at any time. Legacy clients (e.g. odbc, etc.) may have to poll for new messages using a select statement, according to an exemplary embodiment.

using finance_committee;
-- send a message to everyone with role finance_committee_member
message ‘hello, world’ to finance_committee_member
-- private message
message ‘hello, john’ to john_smith;
-- message from stored procedure to user invoking it
message ‘print job completed’;
-- do a long query and send result as a message
-- command returns right away
message ‘big results’ attach select * from big_table;
-- review recent messages
select * from sysmessages limit 30;
-- review only finance committee messages
select * from sysmessages where “role”=‘finance_committee_member’;

### Virtual Machines

Virtual machines may allow the managed file system to be mounted into a running virtualized server, according to an exemplary embodiment. Access to the server may be controlled by the database role based security, and the server's abilities can be used to extend the database's capabilities, according to an exemplary embodiment.

create server test_platform(/xfiles)

platform ‘http://datagrove.com/x.box’

grant start.ssh on test_platform to john_doe at(1/1/2012 to 12/31/2012)
-- grab some stats from the server
select * from server(test_platform)
-- perform an operation on the server using ssh
ssh test_platform ‘ls /xfiles’;

Servers may be members of the schema, according to an exemplary embodiment, so creating a proposal schema may automatically create new server instances, according to an exemplary embodiment. This may be convenient in many cases to be able to test changes in the virtual machine with no additional setup, according to an exemplary embodiment.

### Editor Plugins

Each database may have a schema named SYSPLUGIN, according to an exemplary embodiment. If desired, according to an exemplary embodiment, this schema can be controlled by rules of order like any other schema, according to an exemplary embodiment. By default it may be owned by the sysadmin role, according to an exemplary embodiment. The file system associated with SYSPLUGIN can provide javascript, html, and css files defining plugins that the clients may load as required, according to an exemplary embodiment. The virtual machines associated with SYSPLUGIN may provide server side support for the plugins, according to an exemplary embodiment. Individual schemas may also provide plugins, according to an exemplary embodiment. When a document is loaded into a client editor, the editor may also load the appropriate plugins from the schema and database containing the document, according to an exemplary embodiment. Plugins may be associated with mime types, so different plugins may be loaded depending on the file being edited, according to an exemplary embodiment.

Plugins may be defined in the sysclientplugin table define as (id text, agent text, mime_type text, path text, server text, disabled boolean), according to an exemplary embodiment. The agent may be a unique name that the client application picks and may include a version component (e.g. web 1.0). The mime_type may include the mime_types that the plugin is used for and may include multiple comma separated types and wildcards such as “text/*, application/xml, according to an exemplary embodiment. The path may point the path of the plugin root, according to an exemplary embodiment. The server name, if provided, may be used to indicate a virtual machine that must be running for the plugin to work, according to an exemplary embodiment. The virtual machine may be started automatically when the plugin is loaded, according to an exemplary embodiment.

The capabilities of the client side plugins vary based on the ability of the client, according to an exemplary embodiment. Typical plugins are for syntax coloring and folding of various mime types, according to an exemplary embodiment. Style plugins extend the layout engine responsible for mapping the document text to a visual layout in the graphical view, and may include a CSS file, according to an exemplary embodiment. Command plugins extend the user interface with new menu options, according to an exemplary embodiment. These commands may do little more than execute stored procedures on the server, according to an exemplary embodiment. For example, one standard plugin validates XML files to any referenced schemas, according to an exemplary embodiment. As errors are identified it may update an error list and may send a message to the client to display it to the user, according to an exemplary embodiment. An example of a transformation plugin is the plugin that converts HTML into PDF output, according to an exemplary embodiment.

### Embedding Queries in the Collaborative Editor

HTML5 documents may embed views to the database using custom data attributes: data-sql, data-sql-repeat, and data-sql-field, according to an exemplary embodiment.

<!-- create an html table from an sql table -->
<table data-sql=‘select first,last,phone from users’>
<tr data-sql-repeat>

<td><span data-sql-field=‘first’ /></td>
<td><span data-sql-field=‘last’ /></td>
<td><span data-sql-field=‘phone’ /></td>
</tr></table>

These documents can be viewed in a standard browser by linking in the standard support library ddb.js., according to an exemplary embodiment.

### Customizing the Rules of Order

The rules of order, according to an exemplary embodiment, are defined in a schema with the motions controlled by stored procedures, according to an exemplary embodiment. These stored procedures could take advantage of the virtual machines to implement motion logic in other popular programming languages, according to an exemplary embodiment.

create schema jim_rules from roberts;
using jim_rules;
-- it's easy to change parameters in the standard rules
update sysrules set proxy_meeting = TRUE;
-- it's more involved to invent new motions, but most people don't need to
create motion hoist language javascript in ‘motion_hoist.js’;
motion hoist(days=30) to dues_increase as hoist_dues_increase;
// motion_hoist.js
// Customary in Canada, causes bill to be delayed for 6 months or
specified period of time
hoist = make_motion({

second true,
precedence: 10,
interrupt: false,
debate: true,
amend: true,
vote: .5,
proxy: true,
verify: function(meeting,options){

// this only makes sense if there is a main motion
being considered.

return motion.require_main_motion(meeting);

},

adopt: function(meeting,options){

// schedule the motion on the table for 6 months hence, or
time interval
// specified in the motion

```
  motion.postpone_until((new Date( )).getDate( )+
  (options.days∥180); }
```

});

### Calendar Events

Using create event, according to an exemplary embodiment, commands can be scheduled for the future, and these events may be combined with proposals, motions, and proxies, according to an exemplary embodiment. These motions may be rescinded prior to their execution, according to an exemplary embodiment.

-- combine proxy, motion, at, and adopt to propose a future dues increase
motion sql(create event dues_increase_event (8/1/2012 0:00) as

adopt dues_increase)

as future_increase_motion
by proxy;

```
-- Recurring events and date ranges are also supported.
-- this grant exists only from 9/23 to 9/26
grant select on finance_committee to consultant_john_doe at
(9/23 - 9/26)
create event spending_report(every Monday at 8pm) as
  message finance_commit_members ‘Spending Report’
    attach select * from spending_view;
```

### Triggers

Triggers, according to an exemplary embodiment, are inherited along with data values, but in some cases you need triggers that are only executed on actions for a specific schema, according to an exemplary embodiment. For example, in a payment application one may want propose payments, but only trigger the payment when the proposal is adopted, according to an exemplary embodiment. Such a trigger would be created as “not inherited”, according to an exemplary embodiment.

In addition to the normal table and view triggers there are directory triggers integrated with the schema file system, according to an exemplary embodiment.

create trigger finance_committee.process_edi

on directory /payable
after insert
not inherited
language cpp
file /bin/process_edi.dll

create schema some_accounting from finance_committee;
copy sys.‘edifile’ payable;
-- triggered only when inserted into base; people get paid, receivables
get booked
motion adopt some_accounting;

### Rebasing

Schemas, according to an exemplary embodiment are only adopted into their base schema, and then only if the base schema is modifiable (schemas specified at a point in time are not modifiable; history is not modifiable), according to an exemplary embodiment.

The base schema of a proposal can be altered, according to an exemplary embodiment. Altering the base proposal can cause merge conflicts that are resolved in a type specific way, according to an exemplary embodiment. The default “overwrite” algorithm causes no conflicts, according to an exemplary embodiment. The weave approach is discussed in a later section, according to an exemplary embodiment.

create schema v1 from charter[now];
update v1.core set proxy=true;
-- this is an error - you can't modify history
adopt v1;
-- instead do this
alter schema v1 set base = charter;
adopt v1;

The advantage of the two step process, according to an exemplary embodiment, is that all the changes in the proposal are available for review prior to adoption, according to an exemplary embodiment. For collaborative data types, according to an exemplary embodiment, changing the base can cause merge conflicts that may need to be fixed prior to adoption, according to an exemplary embodiment. This two step process may allow a clean merge into the base after fixes are made, according to an exemplary embodiment.

### Exemplary Processing and Communications Embodiments

FIG. 10 depicts an exemplary diagram of an exemplary computing device hardware architecture illustrating an exemplary device as may be used in any of various client, host, peer and/or server devices, according to an exemplary embodiment of the present invention. FIG. 10, specifically, depicts an exemplary embodiment of a computer system 1000 that may be used in association with, in connection with, and/or in place of, but not limited to, any of the foregoing components and/or systems, according to an exemplary embodiment. Various exemplary electronic computer systems may be networked to one another and integrated to collectively compute and perform elements of the exemplary embodiments. Such computing systems may include, e.g., but are not limited to, one or more, or many of, a server, a web server, an application server, a host, a client, a computing device, a load balancer, a client computing device, a mobile device, a phone, a cell phone, a mobile phone, a personal digital assistant, a cluster device, a network device, a router, a bridge, a gateway, a user device, an organization device, a project device, a user profile device, a user news feed device, a bylaw storage device, a resolution storage device, a resolution enforcement device, a resolution editor, an agenda editor, a debator, a decisionator, a bylaw editor, minute tracker, a history storage device, rules storage device, a rules of order device, a Robert's Rules of order device, diff/patch/merge comparator device, a linking device, an organization directory tree device, an organization announcement device, a person announcement device, a committee device, a news device, a multiorganization news device, an article adding device, a role adding device, a committee adding device, an article editing device, a role editing device, a committee editing device, and/or communication device, among others, etc., according to various exemplary embodiments. It should be noted, however, that the exemplary embodiments of the invention may be implemented on any computing device(s), processor(s), computer(s) and/or communications device(s).

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 1000 is shown in FIG. 10, depicting an exemplary embodiment of a block diagram of an exemplary computer system useful for implementing the present invention. Specifically, FIG. 10 illustrates an example computer 1000, which in an exemplary embodiment may be, e.g., (but not limited to) a personal computer (PC) system running an operating system such as, e.g., (but not limited to) WINDOWS MOBILETM™ for POCKET PC, or MICROSOFT® WINDOWS® 7/XP/NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS, Mac OSX, iOS, etc., from APPLE® Corporation of Cupertino, Calif., U.S.A., etc., ANDROID from Google Corporation, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system, communications, or other device, running any appropriate operating system. In one exemplary embodiment, the present invention may be implemented on a computer system operating as discussed herein. An exemplary computer system, computer 1000 is shown in FIG. 10. Other components of the invention, such as, e.g., (but not limited to) a computing device, a communications device, a telephone, a personal digital assistant (PDA), a personal computer (PC), a handheld PC, an iPhone, an iPAD, a mobile phone, a tablet, a cell phone, client workstations, thin clients, thick clients, proxy servers, network communication servers, remote access devices, client computers, server computers, routers, web servers, data, media, audio, video, telephony or streaming technology servers, tablet, smartphone, etc., may also be implemented using a computer such as that shown in FIG. 10.

The computer system 1000 may include one or more processors, such as, e.g., but not limited to, processor(s) 1004. The processor(s) 1004 may be connected to a communication infrastructure 1006 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 1000 may include a display interface 1002 that may forward, e.g., but not limited to, graphics, text, and other data, etc., from the communication infrastructure 1006 (or from a frame buffer, etc., not shown) for display on the display unit 1030.

The computer system 1000 may also include, e.g., but may not be limited to, a main memory 1008, random access memory (RAM), and a secondary memory 1010, etc. The secondary memory 1010 may include, for example, (but not limited to) a hard disk drive 1012 and/or a removable storage drive 1014, representing a floppy diskette drive, a magnetic tape drive, an optical disk drive, a compact disk drive CD-ROM, an SD ram card, a flash device, a USB storage device, etc. The removable storage drive 1014 may, e.g., but not limited to, read from and/or write to a removable storage unit 1018 in a well known manner. Removable storage unit 1018, also called a program storage device or a computer program product, may represent, e.g., but not limited to, a floppy disk, magnetic tape, optical disk, compact disk, etc. which may be read from and written to by removable storage drive 1014. As will be appreciated, the removable storage unit 1018 may include a computer usable storage medium having stored therein computer software and/or data.

In alternative exemplary embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1022 and interfaces 1020, which may allow software and data to be transferred from the removable storage unit 1022 to computer system 1000.

Computer 1000 may also include an input device such as, e.g., (but not limited to) a mouse or other pointing device such as a digitizer, and a keyboard or other data entry device (none of which are labeled).

Computer 1000 may also include output devices, such as, e.g., (but not limited to) display 1030, and display interface 1002. Computer 1000 may include input/output (I/O) devices such as, e.g., (but not limited to) communications interface 1024, cable 1028 and communications path 1026, etc. These devices may include, e.g., but not limited to, a network interface card, and modems (neither are labeled). Communications interface 1024 may allow software and data to be transferred between computer system 1000 and external devices. Examples of communications interface 1024 may include, e.g., but may not be limited to, a modem, a network interface (such as, e.g., an Ethernet card), a communications port, a Personal Computer Memory Card International Association (PCMCIA) slot and card, etc. Software and data transferred via communications interface 1024 may be in the form of signals 1028 which may be electronic, electromagnetic, optical or other signals capable of being received by communications interface 1024. These signals 1028 may be provided to communications interface 1024 via, e.g., but not limited to, a communications path 1026 (e.g., but not limited to, a channel). This channel 1026 may carry signals 1028, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 1014, a hard disk installed in hard disk drive 1012, and signals 1028, etc. These computer program products may provide software to computer system 1000. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 1008 and/or the secondary memory 1010 and/or removable storage units 1014, also called computer program products. Such computer programs, when executed, may enable the computer system 1000 to perform the features of the present invention as discussed herein. In particular, the computer programs, when executed, may enable the processor 1004 to provide a method to resolve conflicts during data synchronization according to an exemplary embodiment of the present invention. Accordingly, such computer programs may represent controllers of the computer system 1000.

In another exemplary embodiment, the invention may be directed to a computer program product comprising a computer readable medium having control logic (computer software) stored therein. The control logic, when executed by the processor 1004, may cause the processor 1004 to perform the functions of the invention as described herein. In another exemplary embodiment where the invention may be implemented using software, the software may be stored in a computer program product and loaded into computer system 1000 using, e.g., but not limited to, removable storage drive 1014, hard drive 1012 or communications interface 1024, etc. The control logic (software), when executed by the processor 1004, may cause the processor 1004 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc. Bluetooth is an emerging wireless technology promising to unify several wireless technologies for use in low power radio frequency (RF) networks. IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

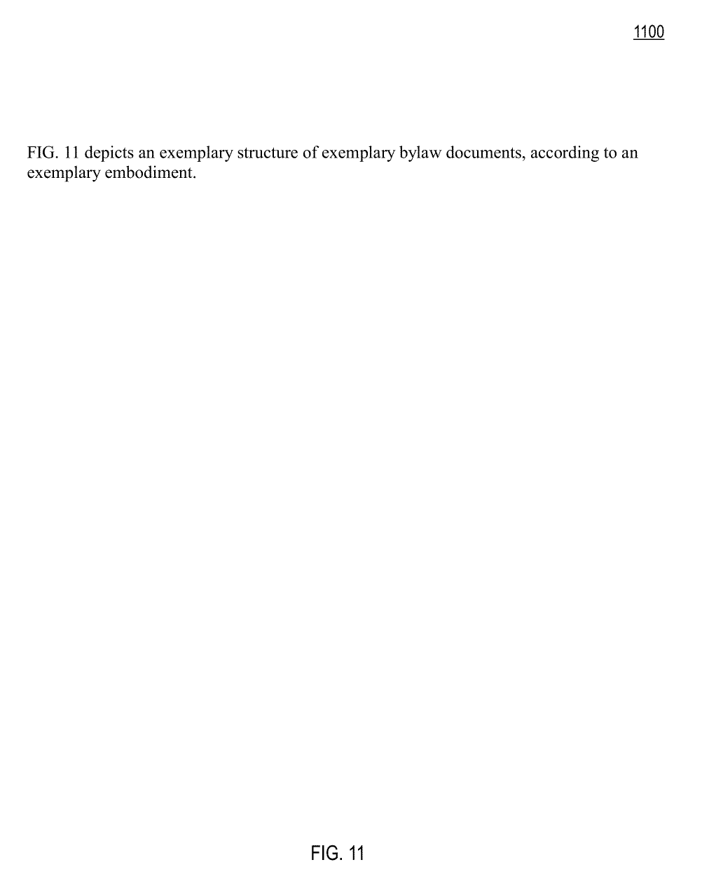

FIG. 11 depicts an exemplary data structure of exemplary bylaw documents, according to an exemplary embodiment.

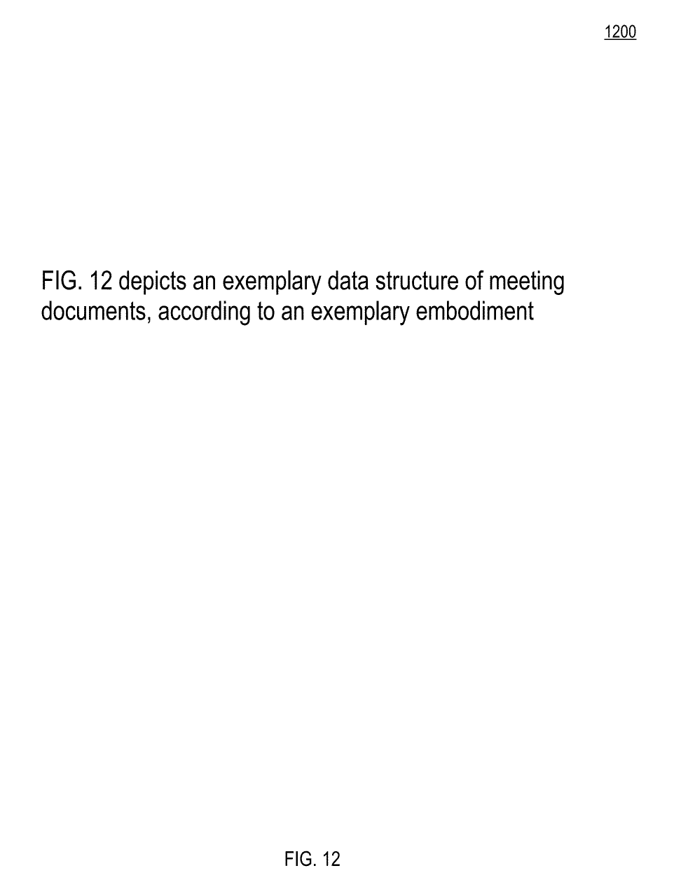

FIG. 12 depicts an exemplary data structure of meeting documents, according to an exemplary embodiment.

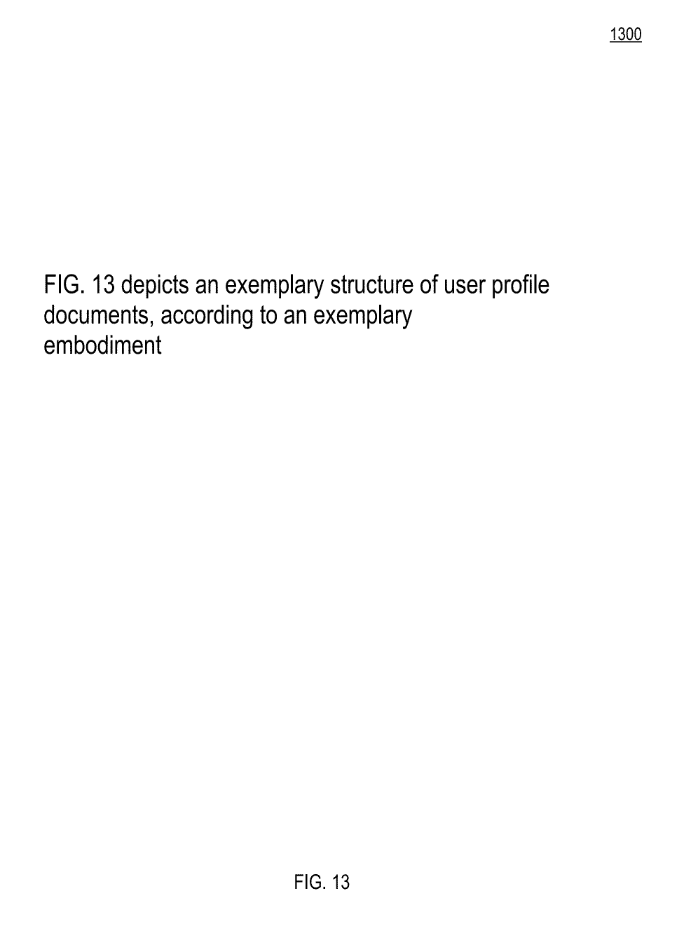

FIG. 13 depicts an exemplary data structure of user profile documents, according to an exemplary embodiment.

FIG. 14 depicts an exemplary data structure for defining an exemplary new set of parliamentary procedures, according to an exemplary embodiment.

FIG. 15 depicts an exemplary data structure for defining an exemplary new server cluster, according to an exemplary embodiment.

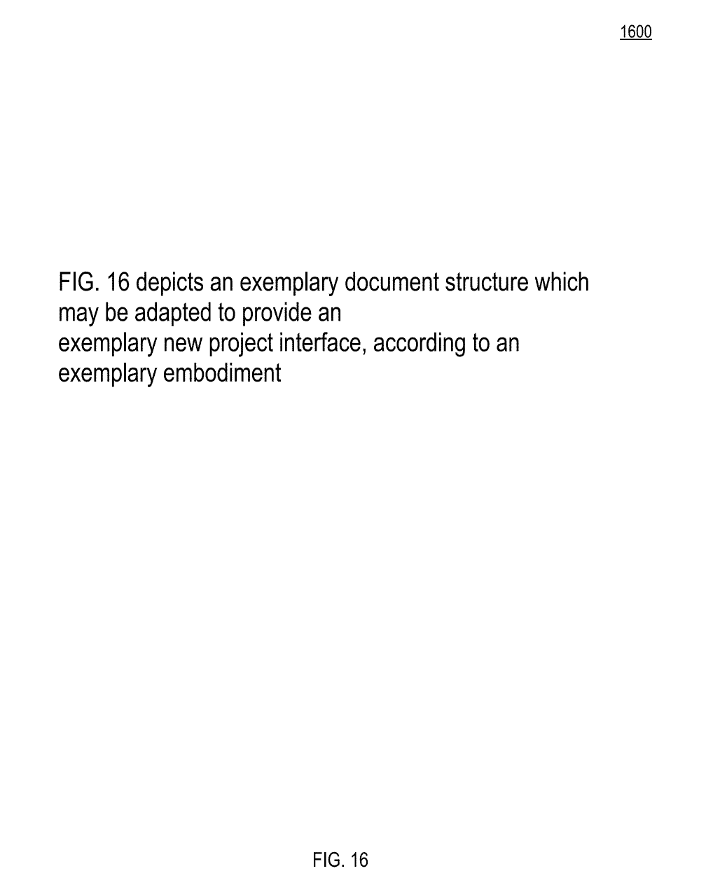

FIG. 16 depicts an exemplary document data structure which may be adapted to provide an exemplary new project interface, according to an exemplary embodiment.

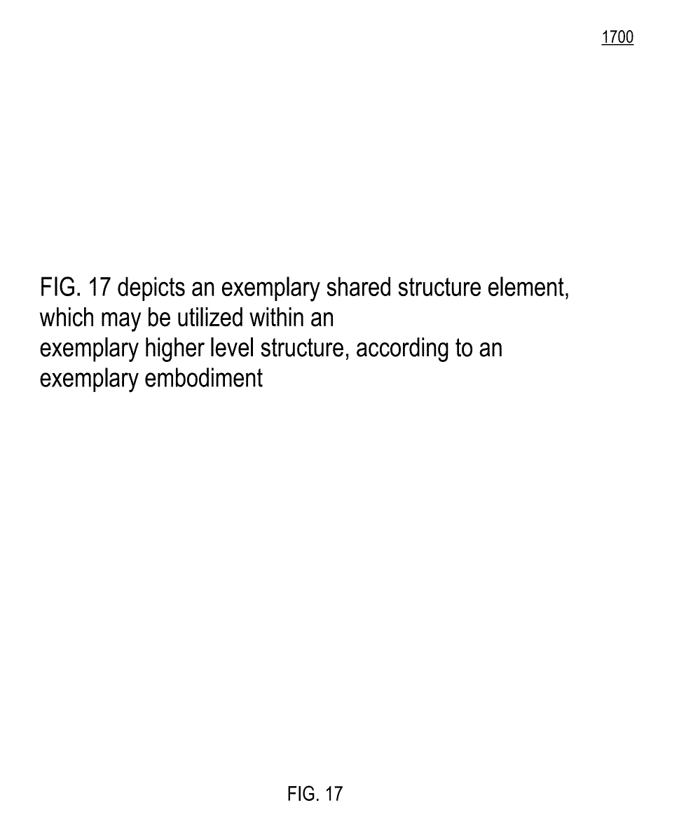

FIG. 17 depicts an exemplary shared data structure element, which may be utilized within an exemplary higher level structure, according to an exemplary embodiment.

FIG. 18 depicts an exemplary user interface illustrating an exemplary top level data structure of the present invention, according to an exemplary embodiment.

### CONCLUSION

In this document, the terms “computer program medium” and “computer readable medium” may be used to generally refer to media such as, e.g., but not limited to removable storage drive, a hard disk installed in hard disk drive, and signals, etc. These computer program products may provide software to computer system. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as, e.g., but not limited to, “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents.

What is claimed is:

1. A method for building structured documents by a collaborative process over computer networks, the method comprising:
receiving, by at least one processor, from at least one organization at least one configurable parliamentary structure;
receiving, by the at least one processor, from the at least one organization at least one organizational bylaw for the at least one organization defined in at least one document; and
receiving, by the at least one processor, at least one edit for said at least one document, adoptable by the at least one organization;
wherein said at least one organizational bylaw comprises computer readable instructions enforceable by the at least one processor system.

2. The method according to claim 1, further comprising:
receiving at least one document kept in multiple versions with versions identifiable with alphanumeric tags;
receiving at least one tagged version adoptable using at least one voting procedure defined within at least one organization's parliamentary procedure (OPP).

3. The method according to claim 1, further comprising:
receiving membership qualifications of the at least one organization defined within the adopted organization parliamentary procedure and enforced by the at least one processor system.

4. The method according to claim 3, wherein the membership qualification involves payment to an organizational purse (dues).

5. The method according to claim 3, wherein the membership qualification members hold organizational offices in a manner controlled by at least one organization's parliamentary procedure (OPP).

6. The method according to claim 1, wherein, the offices held by a user affects the voting procedure as defined with at least one organization's parliamentary procedure (OPP).

7. The method according to claim 1, wherein the users may participate in multiple organizations simultaneously and hold multiple offices.

8. The method according to claim 1, wherein document adoption is scheduled to take place at a specified time and date.

9. The method according to claim 1, wherein each user is allowed to express support or opposition to adoption by varying degrees.

10. The method according to claim 1, further comprising:
creating a relational graph built to allow the system to track allies and oppositional users.

11. The method according to claim 1, further comprising:
organizational graphs allowing hierarchical organizational structure to be easily browsed.

12. The method according to claim 1, further comprising:
a configurable news feed component displaying to at least one user a time or relevancy ordered summation of recent activity of interest by other users.

13. The method according to claim 1, further comprising:
authentication controls for documents to limit users allowed to at least one of view, edit, or adopt resolutions related to the document.

14. The method according to claim 1, further comprising:
enforcing, by checkpoint logic, adopted documents or reporting breaches of adopted documents.

15. The method according to claim 1, further comprising:
communicating rapidly document changes to users holding appropriate authorization.

16. The method according to claim 1, further comprising:
communicating by users within online meeting activities as defined within the OPP.

17. The method according to claim 1, wherein schema documents within the system define structure of documents that are instances of that schema, and further comprising:
collecting document instances, and
allowing search of document instances (cases) that are at least one of:
valid instances of the schema, or
invalid instances of the schema.

18. The method according to claim 1, wherein in a case of invalid instances, further comprising:
displaying deviant aspects of an intended instance.

19. The method according to claim 1, further comprising federating a plurality of systems together to allow organizations that span multiple systems connected by an inter-network to access said plurality of systems.

20. The method according to claim 1, further comprising at least one of:
importing; or exporting from the system using at least one format.

21. The method according to claim 1, further comprising:
maintaining at least one document in a plurality of languages with at least one of automatic or human guided translation, and a user interface distinguishing difference sources of translation.

22. The method according to claim 1, further comprising:
checkpoint software aggregating cases in at least one way comprising at least one of:
scheduled file import, or
publicly available application programming interface (API) or services.

23. The method according to claim 1, further comprising at least one of:
document validation extended with general programming languages kept in coordinated source control, or
document validation adopted in accordance with OPP.

24. The method according to claim 1, further comprising at least one of:
document validation extended with general relational databases and queries against the general databases kept in coordinated source control, or
document validation extended with general relational databases adopted in accordance with OPP.

25. The method according to claim 1, wherein core bylaw system is extensible by programming in a plurality of programming languages comprising at least one of C++, or Python.

26. The method according to claim 1, wherein execution of bylaw code is secured by a virtual machine.

27. The method according to claim 1, wherein meeting participants are assisted in access and use of organizational bylaws, comprising a mobile platform, and at least one of searching or viewing the bylaws or rules of order.

28. The method according to claim 1, wherein documents are enabled for rapid search comprising at least one of:
receiving a user query; or
providing results from multiple projects.

28. The method according to claim 28, further comprising:
receiving a user search query for archived revisions of documents.
